(19) United States
(12) Patent Application Publication
(10) Pub. No.: US 2026/0094959 A1
(43) Pub. Date: Apr. 2, 2026

(54) BRACKET ASSEMBLY AND RELATED ANTENNA MOUNT ASSEMBLIES

(71) Applicant: Outdoor Wireless Networks LLC, Richardson, TX (US)

(72) Inventors: Li Xiang, Suzhou (CN); ZiCheng Su, Suzhou (CN); Charles J. Mann, Omaha, NE (US)

(21) Appl. No.: 19/095,364

(22) Filed: Mar. 31, 2025

(30) Foreign Application Priority Data
Sep. 30, 2024 (CN) 202422397019.6
Dec. 16, 2024 (CN) 202423098112.3

(51) Int. Cl. H01Q 1/12; H01Q 1/20

(52) U.S. Cl. CPC H01Q 1/1228; H01Q 1/20

(57) ABSTRACT

The present disclosure describes a bracket assembly. The bracket assembly includes a base member, a first clamp member coupled to a first side of the base member at a first location, and a second clamp member coupled to an opposing second side of the base member at a second location. The bracket assembly is configured to secure a first member between the first clamp member and the base member and configured to secure a second member between the second clamp member and the base member. The first and second locations are configured to be adjustable to accommodate members having different diameters. Related mount assemblies are also described herein.

### RELATED APPLICATION(S)

The present application claims priority to and the benefit of Chinese Application for Utility Model No. 202422397019.6, filed Sep. 30, 2024, and Chinese Application for Utility Model No. 202423098112.3, filed Dec. 16, 2024, the disclosures of which are hereby incorporated herein in full.

### FIELD

The present application is directed generally toward telecommunications equipment, and more particularly, to a bracket assembly and related antenna mount assemblies.

### BACKGROUND

With increased demand for more wireless communication, the number of radio and antenna units that a tower traditionally supports has increased and is expected to continue to increase. New towers will need to be designed to support greater numbers of antenna and radio units, while existing towers are retrofitted to support more units, and effort is made to fully utilize space available on the towers. An exemplary sector frame antenna mount assembly 10 is illustrated in FIGS. 1A-1B. The sector frame antenna mount assembly 10 includes a sector frame 20 for antenna mounting and an offset mount 30. The sector frame 20 includes horizontal members (pipes) 22 and vertical members (pipes) 24 which allow the mounting of antennas (not shown) thereon. The offset mount 30 is configured to be secured to the horizontal members 22 of the sector frame 20 (e.g., via mounting brackets or other fasteners 35) and may be used to position and secure the sector frame 20 (and antennas mounted thereon) a distance from a mounting structure (not shown). The sector frame 20 may also include one or more tie-back pipes 12 secured to the horizontal members 22 (via mounting brackets or other fasteners 15). See also, e.g., U.S. Pat. No. 9,812,762 to Skrepcinski et al. ; U.S. Pat. No. 9,853,346 to Skrepcinski et al. ; and U.S. Pat. No. 10,122,064 to Skrepcinski et al., the disclosures of which are hereby incorporated herein in full.

The vertical members 24 are secured to the horizontal members 22 and are spaced apart along the length of the horizontal members 22 at least a minimum distance from each other to help mitigate or eliminate interference between the antennas. Typically, the horizontal and vertical members 22, 24 are formed from steel and are secured together via a mechanical connection 20, e.g., U-bolts, mounts, or other steel connection. The mechanical connections 20 (e.g., U-bolts) provide a sufficient clamp load to secure the horizontal and vertical members 22, 24 together to form the antenna frame 30 and maintain the structural support necessary such that telecommunications equipment (e.g., antennas or radios) may be secured to the antenna frame 30. However, installation of these mechanical connections are complex and has potential inefficiencies. Thus, there may be a need for alternative mechanical connections to secure crossing members together.

### SUMMARY

A first aspect of the present invention is directed to a bracket assembly. The bracket assembly includes a base member, a first clamp member coupled to a first side of the base member at a first location, and a second clamp member coupled to an opposing second side of the base member at a second location. The bracket assembly is configured to secure a first member between the first clamp member and the base member and configured to secure a second member between the second clamp member and the base member. The first and second locations are configured to be adjustable to accommodate members having different diameters.

A second aspect of the present invention is directed to a mount assembly. The mount assembly includes a horizontally-extending member, a vertically-extending member, and a bracket assembly. The bracket assembly includes a base member, a first clamp member coupled to a first side of the base member at a first location, and a second clamp member coupled to an opposing second side of the base member at a second location. The horizontally-extending member is secured between the first clamp member and the base member and the vertically-extending member is secured between the second clamp member and the base member. The first and second locations are configured to be adjustable to accommodate a horizontally-extending member having a first diameter and a vertically-extending member having a second diameter.

A third aspect of the present invention is directed to a bracket assembly. The bracket assembly includes a base member, a first clamp member, and a second clamp member. A first end of the first clamp member is pivotably coupled to a first side of the base member at a first location and a second opposing end of the first clamp member is configured to be secured to the base member to secure a first pipe member between the first clamp member and the base member. A first end of the second clamp member is pivotably coupled to a second opposing second side of the base member at a second location and a second opposing end of the second clamp member is configured to be secured to the base member to secure a second pipe member between the second clamp member and the base member. The first and second locations are configured to be adjustable to accommodate pipe members having different diameters.

A fourth aspect of the present invention is directed to a mount assembly. The mount assembly includes a first pipe member extending generally horizontally relative to a ground plane, a second pipe member extending generally vertically relative to the ground plane, and a bracket assembly. The bracket assembly includes a base member and a clamp member pivotably coupled to a first side of the base member. The first pipe member is secured between the clamp member and the base member, and he second pipe member is secured to a second opposing side of the base member with a fastener.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1A is a perspective view of a known antenna mount assembly.

FIG. 1B is a front view of the antenna mount assembly shown in FIG. 1A.

FIG. 2A is a perspective view of a bracket assembly according to embodiments of the present invention.

FIG. 2B is an exploded view of the bracket assembly shown in FIG. 2A.

FIGS. 3A-3B are additional perspective views of the bracket assembly shown in FIGS. 2A-2B.

FIGS. 4A-4D are different perspective views illustrating the bracket assembly shown in FIGS. 2A-2B and FIGS. 3A-3B securing larger diameter (e.g., 2.875-inch diameter) overlapping members together according to embodiments of the present invention.

FIGS. 5A-5B are different perspective views illustrating the bracket assembly shown in FIGS. 2A-2B and FIGS. 3A-3B securing smaller diameter (e.g., 2.375-inch diameter) overlapping members together according to embodiments of the present invention.

FIGS. 6A-6E are perspective views that illustrate exemplary installation steps for securing a first member and a second member together utilizing the bracket assembly shown in FIGS. 2A-2B and FIGS. 3A-3B according to embodiments of the present invention.

FIGS. 7A-7D are perspective views that illustrate how the bracket assembly can accommodate members having various sizes (e.g., diameters) according to embodiments of the present invention.

FIG. 8A is a perspective view that illustrates an alternative bracket assembly according to embodiments of the present invention.

FIG. 8B is an enlarged perspective view of the pivot location between the clamp member and base member of the bracket assembly shown in FIG. 8A according to embodiments of the present invention.

FIG. 9A is an exploded perspective view of an another alternative bracket assembly according to embodiments of the present invention.

FIG. 9B is a perspective view of the bracket assembly shown in FIG. 9A.

FIG. 10A is an exploded perspective view of another alternative bracket assembly according to embodiments of the present invention.

FIG. 10B is an enlarged view of the pivot location of the bracket assembly shown in FIG. 10A.

FIG. 11A and FIG. 11B are top views of an antenna mount assembly utilizing the bracket assembly shown in FIG. 10A and illustrating the capability of the bracket assembly for use with different diameter vertical and/or horizontal members according to embodiments of the present invention.

FIG. 12A is an exploded perspective view of an alternative configuration for the bracket assembly shown in FIG. 10A according to embodiments of the present invention.

FIG. 12B is a rear perspective view of an antenna mount assembly utilizing the bracket assembly shown in FIG. 12A according to embodiments of the present invention.

FIG. 12C is a front perspective view of the antenna mount assembly shown in FIG. 12B.

FIG. 13A is a perspective view of an alternative bracket assembly according to embodiments of the present invention.

FIG. 13B is an enlarged top view of the boxed end of a clamp member for the bracket assembly as indicated in FIG. 13A

FIG. 13C is a perspective view of the end of the clamp member shown in FIG. 13B without the fastener.

FIG. 13D is a top perspective view of one of the clamp members for the bracket assembly shown in FIG. 13A.

FIG. 14A is a top view of one of the clamp members for the bracket assembly shown in FIG. 13A.

FIG. 14B is a perspective view of the clamp member shown in FIG. 14A transposed over a clamp member for the bracket assembly shown in FIG. 10A.

FIG. 15A is a side view of the bracket assembly shown in FIG. 13A.

FIG. 15B is a side view of the bracket assembly shown in FIG. 15A secured to a vertical and horizontal member according to embodiments of the present invention.

FIGS. 16A-16B are side views of the bracket assembly shown in FIG. 13A illustrating the capability of the bracket assembly for use with different diameter vertical and/or horizontal members according to embodiments of the present invention.

FIG. 17A is another perspective view of the bracket assembly shown in FIG. 13A.

FIG. 17B is an enlarged partial cross-sectional view of the boxed section of the base member for the bracket assembly as indicated in FIG. 17A.

FIG. 18A is another perspective view of the bracket assembly shown in FIG. 13A.

FIG. 18B is a side view of the bracket assembly shown in FIG. 18A secured to a member.

FIG. 19A is a perspective view of the bracket assembly shown in FIG. 13A secured to a vertical and horizontal member according to embodiments of the present invention.

FIG. 19B is a perspective view of a locking mechanism for the bracket assembly according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown. Like numbers refer to like elements throughout and different embodiments of like elements can be designated using a different number of superscript indicator apostrophes (e.g., 10′, 10″, 10″′).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or”includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

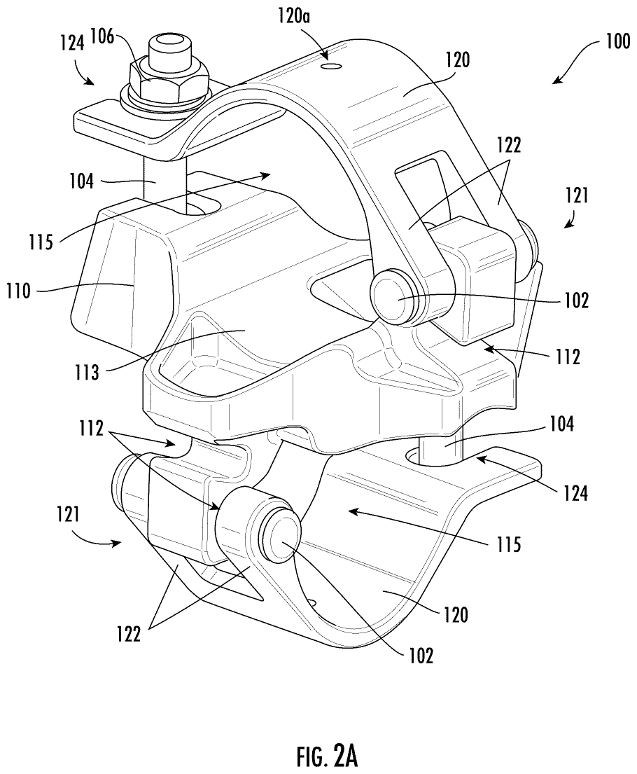

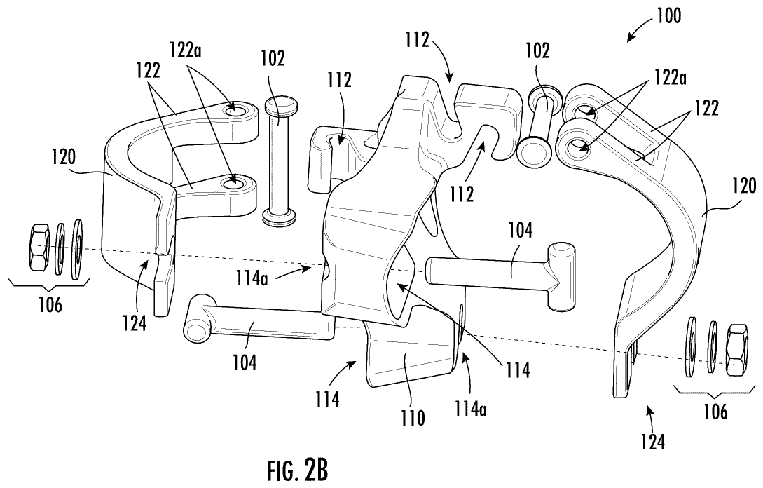

Pursuant to embodiments of the present invention, a bracket assembly is provided that is configured to provide quick and easy securement of a first (e.g., horizontal) member to a second (e.g., vertical) member for an antenna mount assembly. According to embodiments of the present invention, the bracket assembly may also be adjustable to accommodate members having a range of different diameters. Embodiments of the present invention will now be discussed in greater detail with reference to FIGS. 2A-19B.

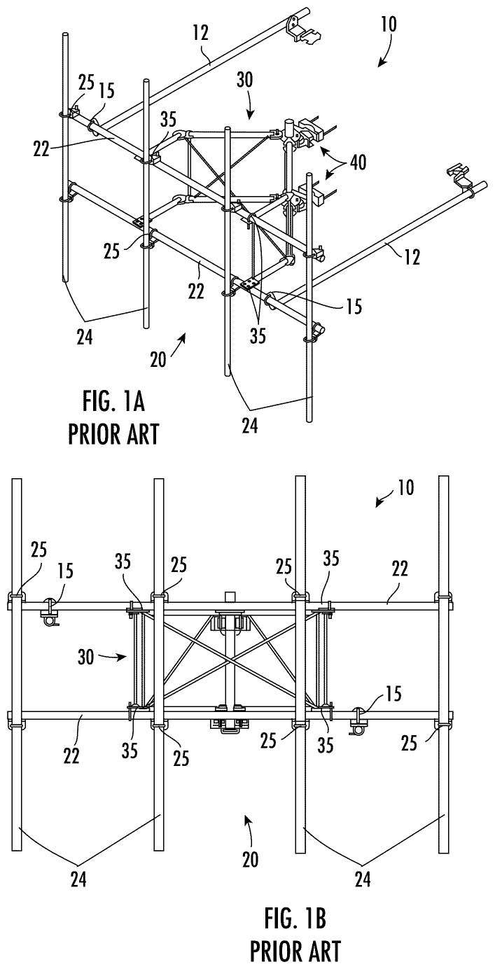

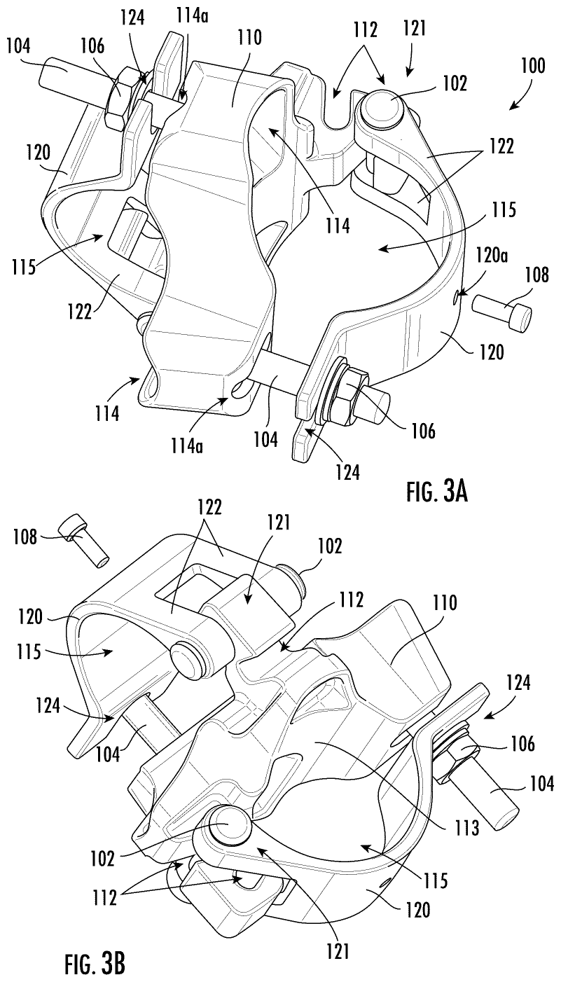

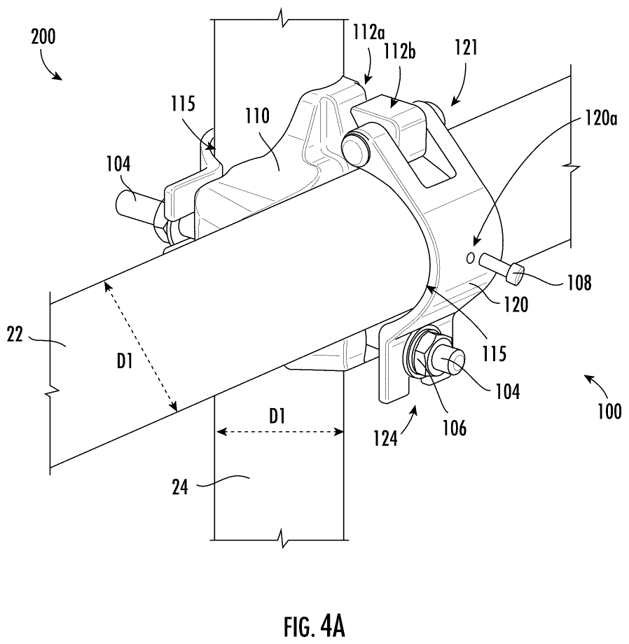

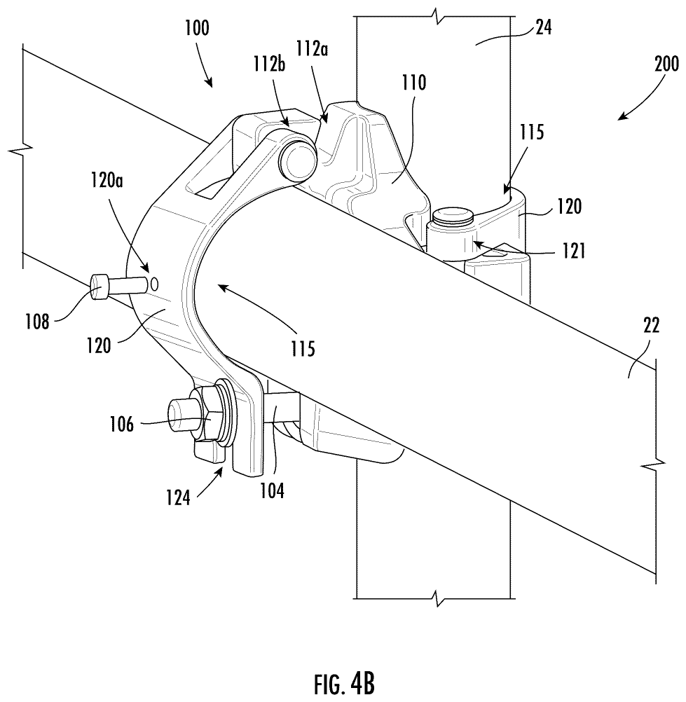

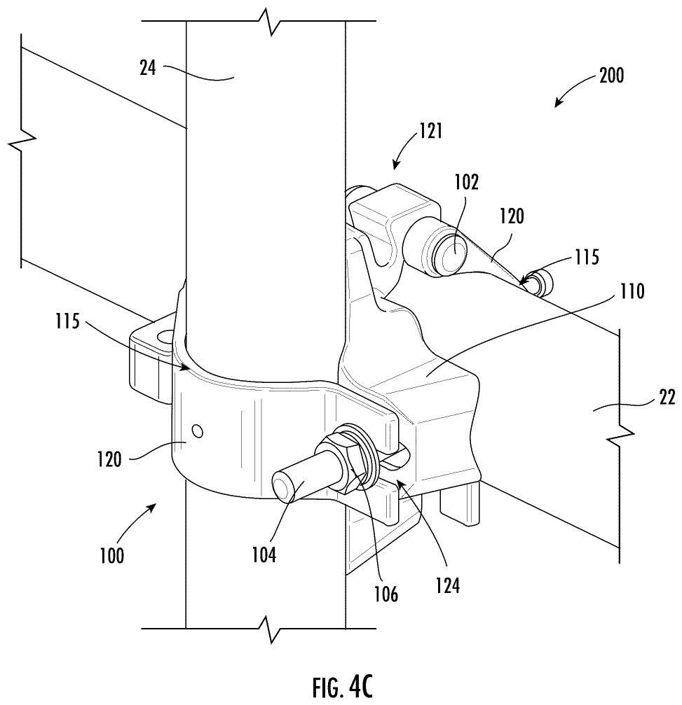

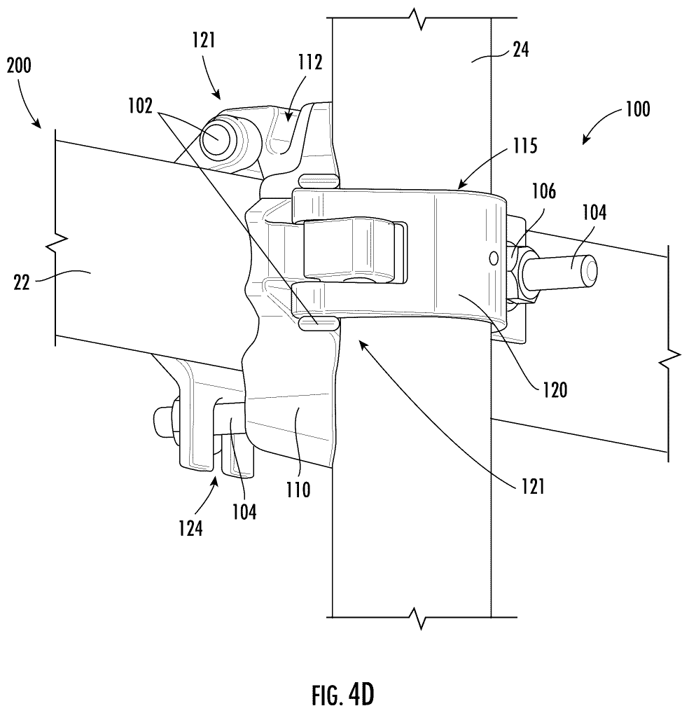

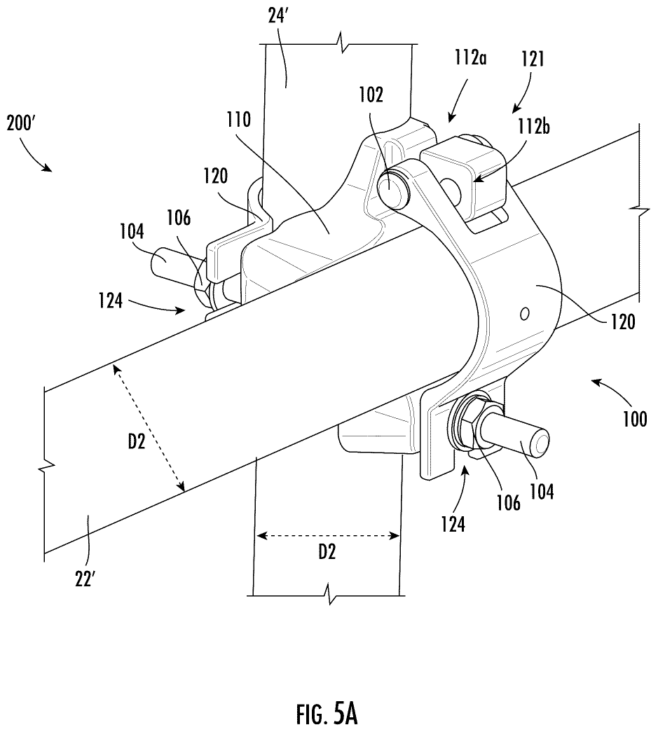

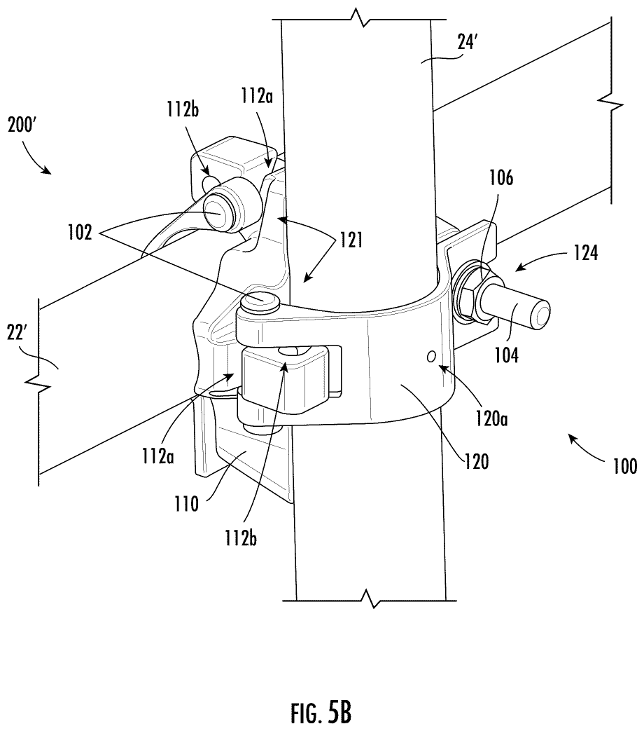

Referring now to FIGS. 2A-2B and FIGS. 3A-3B, a bracket assembly 100 according to embodiments of the present invention is illustrated. According to embodiments of the present invention, the bracket assembly 100 is configured to secure a first member 22 (e.g., a pole, pipe or other like member) to a second member 24 (e.g., a pole, pipe or other like member) (see, e.g., FIGS. 4A-4D and FIGS. 5A-5B). In some embodiments, the first member 22 may be a horizontal or horizontally-extending member and the second member 24 may be a vertical or vertically-extending member such as the horizontal and vertical members 22, 24 discussed above and illustrated in FIGS. 1A-1B. As used herein, the terms “horizontal” and “horizontally-extending” mean substantially parallel relative to a ground plane and the terms “vertical” and “vertically-extending” mean substantially perpendicular relative to the ground plane. However, in some embodiments, the first or second member 22, 24 may not be oriented substantially horizontal or vertical to a ground plane. For example, in some embodiments, the bracket assembly 100 may be configured to secure a tie-back pipe 12 or part of an offset mount 30 (see, e.g., FIG. 1A) to a first or second member 22, 24.

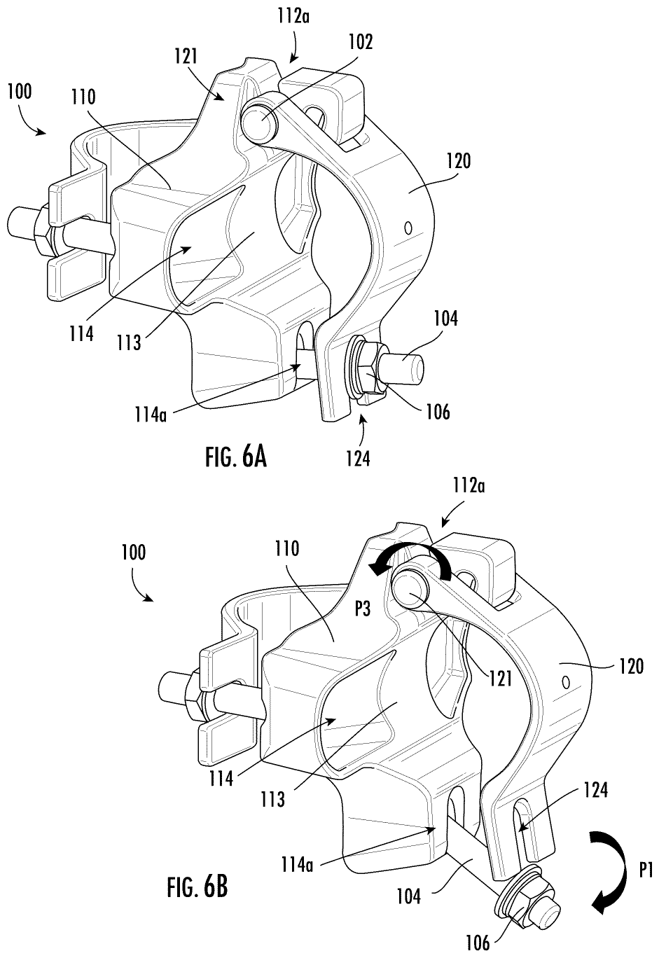

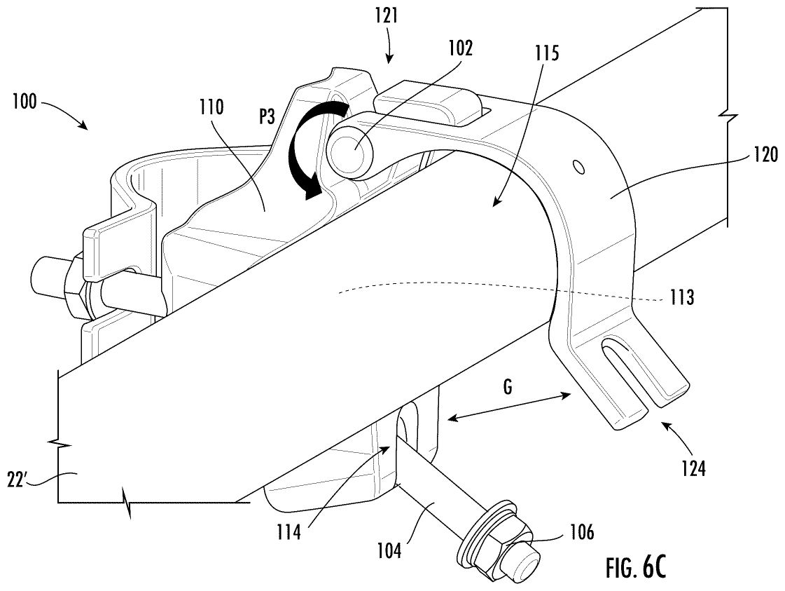

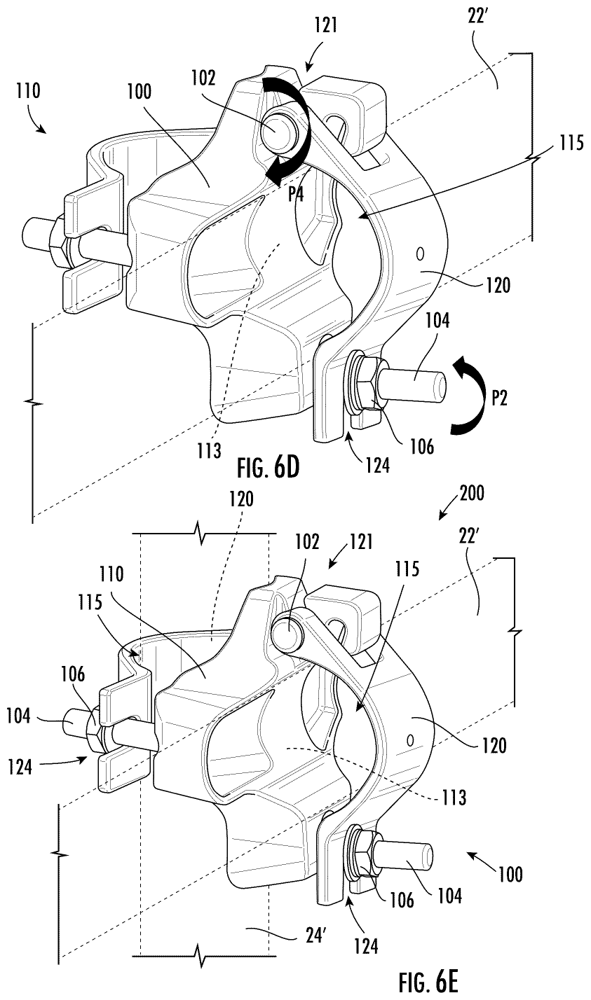

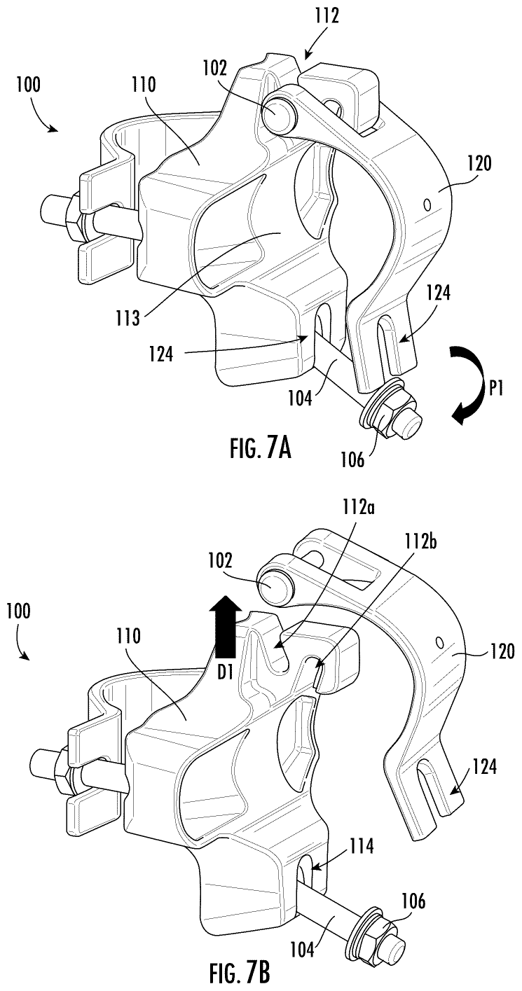

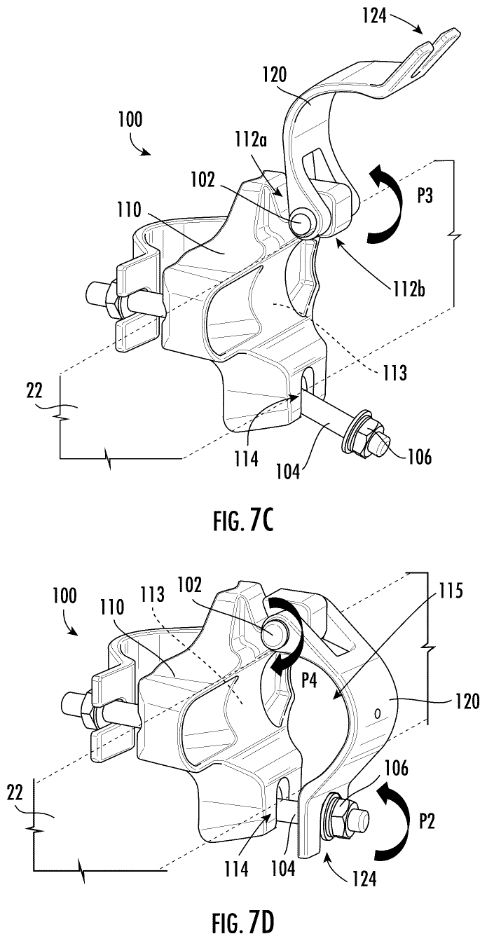

In some embodiments, the first and second members 22, 24 may form part of an antenna mount assembly, such as, the sector frame antenna mount assembly 10 illustrated in FIGS. 1A-1B. However, this use is not limiting, and the bracket assembly 100 of the present invention may be used in other types of mount assemblies as a mechanical connection between a first member 22 and a second member 24. According to embodiments of the present invention, the bracket assembly 100 is configured to secure two members 22, 24 together at a location where the two members 22, 24 overlap, cross-over, or otherwise intersect each other. According to further embodiments, the bracket assembly 100 of the present invention may be configured to be adjustable to accommodate different sizes (e.g., diameters) of members 22, 24. In other words, the bracket assembly 100 of the present invention may be configured to secure together members 22, 24 within a range of diameters. (see, e.g., FIGS. 6A-6E and FIGS. 7A-7D).

As shown in FIGS. 2A-2B and FIGS. 3A-3B, in some embodiments, the bracket assembly 100 comprises a base member 110 and two clamp members 120. The clamp members 120 are each coupled to opposing sides of the base member 110 and configured to secure a first (e.g., horizontal) member 22 or a second (e.g., vertical) member 24 therebetween (see, e.g., FIGS. 4A-4D and FIGS. 5A-5B). In some embodiments, one or more of the components of the bracket assembly 100 may be formed from a metallic material (e.g., steel). In some embodiments, one or more of the metallic components of the bracket assembly 100 may be cladded or covered with a polymeric coating (e.g., rubber or plastic) to help minimize any passive intermodulation (PIM) that could be created from the metal-to-metal contacts between the bracket assembly 100 and the members 22, 24. In other embodiments, one or more of the components of the bracket assembly 100 may be formed from a non-metallic (e.g., polymeric) material, thereby reducing the metal-to-metal contacts and further helping to minimize PIM.

In some embodiments, each clamp member 120 is pivotably coupled to the base member 110. In some embodiments, a shaft member 102 (e.g., a pin, a rod or like member) resides at an end of each clamp member 120. In some embodiments, the shaft member 102 may define a pivot location 121 with the base member 110. In some embodiments, a pair of arms 122 reside at the end of each clamp member 120. In some embodiments, the pair of arms 122 are spaced apart from each other and extend outwardly from the end of the respective clamp member 120. In some embodiments, each arm 122 comprises an aperture 122a configured to receive the shaft member 102 therethrough. In other embodiments, the shaft member 102 may be integrally formed with the end of each clamp member 120 and extends between the pair of arms 122.

As described in further detail below, in some embodiments, the shaft member 102 is configured to engage with the base member 110 to form a pivot location 121 between the clamp member 120 and the base member 110 which will allow the clamp member 120 to be moved (i.e., rotated or pivoted) to an opened position such that a respective member (i.e., first or second member 22, 24) may be positioned in an opening 115 between the clamp member 120 and the base member 110. As shown in FIG. 2B, in some embodiments, the opposing ends of each clamp member 120 comprise a recess 124. Each recess 124 is configured to receive a respective fastener 104 that is configured to secure the corresponding clamp member 120 in a closed position (i.e., once the respective member 22, 24 has been positioned in the opening 115 between the clamp member and the base member 110) (see, e.g., FIG. 2A and FIGS. 3A-3B).

Still referring to FIG. 2B, in some embodiments, the base member 110 comprises a plurality of slotted recesses 112. In some embodiments, at least one slotted recess 112 resides on each opposing side of the base member 110. In some embodiments, each opposing side of the base member 110 comprises a pair of adjacent slotted recesses 112 (e.g., an inner slotted recess 112a and an outer slotted recess 112b). As shown in FIG. 2B, in some embodiments, each open end of the adjacent slotted recesses 112 are positioned in opposing directions. In some embodiments, the slotted recesses 112 are configured to receive the respective shaft members 102 (i.e., allow the clamp members 120 to engage with the base member 110) to form the pivot locations 121 with the respective clamp member 120. As described in further detail below, in some embodiments, the adjacent slotted recesses 112 allow the position of the respective pivot locations 121 between the clamp members 120 and the base member 110 to be adjusted, thereby allowing bracket assembly 100 to accommodate different sizes (e.g., diameters D1, D2) of first and/or second members 22, 24.

In some embodiments, the base member 110 further comprises a pair of housing cavities 114, each housing cavity 114 each having a corresponding aperture 114a (see also FIGS. 6A-6B). Each cavity 114 and corresponding aperture 114a is configured to receive a respective fastener 104. As discussed above, in some embodiments, each fastener 104 is configured engage with a respective clamp member 120 to secure the clamp member 120 in a closed position relative to the base member 110 to secure a respective first member 22 or second member 24 therebetween (see, e.g., FIG. 2A and FIGS. 3A-3B). As shown in FIG. 2B, in some embodiments, the fasteners 104 may be T-type swing bolts. In other embodiments, the fasteners 104 may be ball-ended fasteners. In some embodiments, the cross-end of the T-bolt fastener 104 (or ball of the ball-ended fastener) is configured to be held within the housing cavity 114 of the base member 110 as the opposing end extends through the corresponding aperture 114a to engage and be secured to the corresponding clamp member 120 via coupling components 106, e.g., washers and a nut.

In some embodiments, each clamp member 120 may have an arcuate or convex shape or profile and the corresponding sides of the base member 110 may have an arcuate or concave recess or profile 113. As discussed above, each clamp member 120 and base member 110 together define an opening 115 configured to receive the respective member 22, 24 therebetween. In some embodiments, the configurations of the clamp members 120 and corresponding sides of the base member 110 (i.e., corresponding convex and concave profiles) allow for the bracket assembly 100 to have larger contact surface areas to engage with the outer diameters of the respective member 22, 24 held therebetween, i.e., when the clamp members 120 are pivoted into the closed position relative to the base member 110.

As shown in FIGS. 3A-3B, in some embodiments, each clamp member 120 may further comprise an additional aperture 120a. In some embodiments, the additional aperture 120a may reside in a generally central location between the opposing ends of the clamp member 120. In some embodiments, the additional aperture 120a may be configured to receive a fastener 108 that will engage or contact the respective member 22, 24 held between the clamp member 120 and the base member 110. In some embodiments, the fastener 108 may help to further secure the respective member 22, 24 between the clamp member 120 and the base member 110 and may also help to minimize longitudinal movement of the respective members 22, 24 relative to the bracket assembly 100. In some embodiments, the aperture 120a may also be used as an indicator to help locate a position on the respective member 22, 24 where the clamp member 120 should be secured. For example, in some embodiments, the aperture 120a may be used as a visual “window” to help locate a positioning mark on the respective member 22, 24 which identifies the location to secure the clamp member 120.

FIGS. 4A-4D illustrate a mechanical connection assembly 200 according to embodiments of the present invention in which the bracket assembly 100 of the present invention is used to secure a first (e.g., horizontal) member 22 to a second (e.g., vertical) member 24 when the first member 22 and second member 24 have a first diameter D1. In some embodiments, the diameter D1 of the members 22, 24 may be about 2.875 inches or more. As shown in FIGS. 4A-4D, in some embodiments, the pivot location 121 of the clamp members 120 may be positioned in an outer slotted recess 112b (of the adjacent slotted recesses 112) relative to the base member 110. In other words, the shaft member 102 of the respective clamp members 120 is positioned within the outer slotted recesses 112b of the base member 110, thereby positioning the clamp members 120 such that the bracket assembly 100 of the present invention may accommodate members 22, 24 having a (larger) diameter D1.

As further shown in FIGS. 4A-4D, the clamp members 120 are secured in the closed position relative to the base member 110 via the fasteners 104 and coupling components 106, thereby securing the respective member 22, 24 between the clamp member 120 and base member 110 of the bracket assembly 100. As shown, an end of each fastener 104 is received within the corresponding recesses 124 in the clamp members 120 and the coupling components 106 are tightened thereon to secure the end of each clamp member 120 against the base member 110. Optionally, in some embodiments, another fastener 108 may be inserted into the aperture 120a in the respective clamp member 120 to further secure the respective member 22, 24 between the clamp member 120 and the base member 110.

FIGS. 5A-5B illustrate another mechanical connection assembly 200′ according to embodiments of the present invention in which the bracket assembly 100 of the present invention is used to secure a first (e.g., horizontal) member 22 to a second (e.g., vertical) member 24 when the first member 22 and second member 24 have a smaller second diameter D2, i.e., have a smaller diameter D2 than the diameter D1 of the members 22, 24 illustrated in FIGS. 4A-4D (D2<D1). In some embodiments, the diameter D2 of the members 22, 24 may be about 2.375 inches or less. According to embodiments of the present invention, as shown in FIGS. 5A-5B, the mechanical connection assembly 200′ differs from the mechanical connection assembly 200 shown in FIGS. 4A-4D in that the pivot locations 121 of the respective clamp members 120 are now positioned in an inner slotted recess 112a (of the adjacent slotted recesses 112) relative to the base member 110. In other words, the shaft member 102 of each clamp member 120 is positioned within the respective inner slotted recess 112a of the base member 110, thereby positioning the clamp members 120 such that the bracket assembly 100 of the present invention may accommodate the members 22, 24 having a (smaller) diameter D2.

Similar to the mechanical connection assembly 200, as further shown in FIGS. 5A-5B, in the mechanical connection assembly 200′, the clamp members 120 are secured in the closed position relative to the base member 110 via the fasteners 104 and coupling components 106, thereby securing the respective member 22, 24 between the clamp member 120 and base member 110 of the bracket assembly 100. As shown, an end of each fastener 104 is received within the corresponding recesses 124 in the clamp members 120 and the coupling components 106 are tightened thereon to secure the end of the clamp members 120 against the base member 110. As described herein, optionally, in some embodiments, another fastener 108 may be inserted into the aperture 120a in the respective clamp member 120 to further secure the respective member 22, 24 between the clamp member 120 and the base member 110 (similar to the mechanical connection assembly 200 shown in FIGS. 4A-4D).

Exemplary steps for installing the bracket assembly 100 of the present invention with respect to a first (e.g., horizontal) member 22′ and a second (e.g., vertical) member 24′ having a (smaller) diameter D2 together are illustrated in FIGS. 6A-6E. FIG. 6A illustrates the bracket assembly 100 in a closed and locked position. As shown in FIG. 6A, the shaft member 102 of the clamp members 120 is positioned within the respective inner slotted recess 112a of the base member 110, and the clamp members 120 are pivoted relative to the base member 110 (about pivot locations 121) and the opposing ends of the clamp members 120 are secured to the base member 120 via the fasteners 104 and coupling components 106.

As shown in FIG. 6B, to secure the bracket assembly 100 to the first member 22′, first, the coupling components 106 are loosened which allows the fastener 104 to be moved (e.g., pivoted) in a first direction P1 out of the recess 124 in the end of the clamp member 120. As described herein, in some embodiments, the fastener 104 may be a T-type swing bolt (or ball-ended fastener), which allows one end of the fastener 104 to remain engaged with the base member 110 (e.g., within the housing cavity 114) while the opposing end of the fastener 104 is moved (pivoted) out of the recess 124 in the clamp member 120. Once the end of the fastener 104 is removed from the recess 124 in the clamp member 120, the clamp member 120 is able to be rotated (pivoted) in a counterclockwise direction P3 (i.e., about pivot location 121) and move the opposing end of the clamp member 120 a distance G from the base member 110 (see also FIG. 6C). In some instances, a user may place a finger over the inner slotted recess 112a to help prevent the shaft member 102 of the clamp member 120 from moving out of the recess 112a as the clamp member 120 is being rotated (pivoted) about the pivot location 121.

As shown in FIG. 6C, the clamp member 120 is continued to be rotated (pivoted) about the pivot location 121 in the counterclockwise direction P3 until the opposing end of the clamp member 120 has been moved a sufficient distance G from the base member 110 such that the first member 22′ is able to be received within the opening 115 between the clamp member 120 and the base member 110. In some embodiments, the first member 22′ may be positioned within the opening 115 such that at least a portion of the first member 22′ contacts the concave side 113 of the base member 110.

As shown in FIG. 6D, after the first member 22′ is positioned within the opening 115 (and against the base member 110), the clamp member 120 is rotated (pivoted) about the pivot location 121 in an opposite (i.e., clockwise) direction P4 into the closed position. The fastener 104 is then moved (e.g., pivoted) in a second opposite direction P2 until the end of the fastener 104 is received within the recess 124 in the end of the clamp member 120. Once within the fastener 104 is positioned within the recess 124 of the clamp member 120, the corresponding coupling components 106 are tightened thereon to secure the end of the clamp member 120 to the base member 110 in a closed and locked position. As shown in FIG. 6E, according to embodiments of the present invention, the same steps as described above with respect to securing the first member 22′ to the bracket assembly 100 may be followed with respect to the other clamp member 120 to secure the second member 24′ to the bracket assembly 100.

FIGS. 7A-7D illustrate how the bracket assembly 100 is adjustable such that members 22, 24 having a larger diameter (e.g., D1) may be secured together. FIG. 7A illustrates the bracket assembly 100 in a closed and locked position (similar to the starting position shown in FIG. 6A). As shown in FIG. 7A, the shaft member 102 of the clamp members 120 is positioned within the respective inner slotted recess 112a of the base member 110, and the clamp members 120 are pivoted relative to the base member 110 (about pivot locations 121) and the opposing ends of the clamp members 120 are secured to the base member 120 via the fasteners 104 and coupling components 106. The coupling components 106 are loosened which allows the fastener 104 to be moved (e.g., pivoted) in the first direction P1 out of the recess 124 in the end of the clamp member 120. As described herein, in some embodiments, the fastener 104 may be a T-type swing bolt or ball-ended fastener, which allows one end of the fastener 104 to remain engaged with the base member 110 (e.g., within the housing cavity 114) while the opposing end of the fastener 104 is moved (pivoted) out of the recess 124 in the clamp member 120.

As shown in FIG. 7B, once the fastener 104 is removed from the recess 124 in the clamp member 120, the clamp member 120 is able to be disengaged from the base member 110 by moving (e.g., lifting) the shaft member 102 of the clamp member 120 in a first direction D1 out from the inner slotted recess 112a. The clamp member 120 may be re-engaged with the base member 110 by inserting the shaft member 102 of the clamp member 120 into the outer slotted recess 112b of the base member 110 (see, e.g., FIG. 7C). Moving the shaft member 102 from the inner slotted recess 112a to the outer slotted recess 112b of the base member 110 moves the pivot location 121 of the clamp member 120 outwardly relative to the base member 110 which increases the size of the opening 115 between the clamp member 120 and the base member 110, and thereby allows the bracket assembly 100 to accommodate a larger diameter (e.g., D1) member 22, 24.

As shown in FIG. 7C, once the clamp member 120 is re-engaged with the base member 110, similar to described herein, the clamp member 120 is able to be rotated (pivoted) in the counterclockwise direction P3 (i.e., about pivot location 121) to move the opposing end of the clamp member 120 into an opened position. The clamp member 120 is opened a sufficient distance from the base member 110 such that the first member 22 is able to be received within the larger opening 115 between the clamp member 120 and the base member 110. In some embodiments, the first member 22 may be positioned within the opening 115 such that at least a portion of the first member 22 contacts the concave side 113 of the base member 110.

As shown in FIG. 7D, after the first member 22 is positioned within the opening 115 (and, in some embodiments, against the base member 110), the clap member 120 is rotated (pivoted) about the pivot location 121 in the opposite (i.e., clockwise) direction P4 into the closed position. The fastener 104 is then moved (e.g., pivoted) in the second opposite direction P2 until at least a portion of the fastener 104 is received within the recess 124 in the end of the clamp member 120. Once the fastener 104 is positioned within the recess 124 of the clamp member 120, the corresponding coupling components 106 are tightened thereon to secure the end of the clamp member 120 to the base member 110 in a closed and locked position. According to embodiments of the present invention, the same steps as described above with respect to securing the first member 22 to the bracket assembly 100 may be followed with respect to the other clamp member 120 in order to secure the second member 24 to the bracket assembly 100 (and to the first member 22).

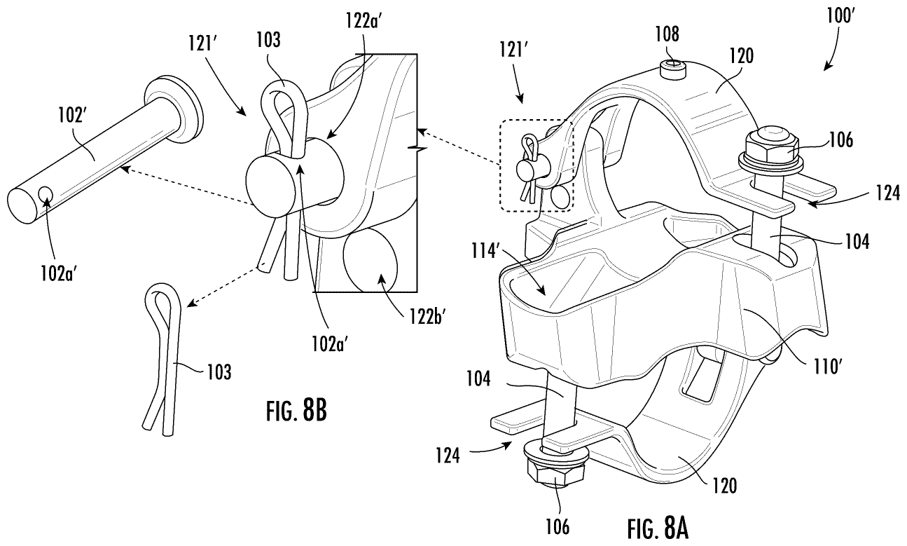

Referring now to FIGS. 8A-8B, an alternative bracket assembly 100′ according to embodiments of the present invention is illustrated. Properties and/or features of the bracket assembly 100′ may be as described above in reference to the bracket assembly 100 described herein and duplicate discussion thereof may be omitted herein for the purposes of discussing FIGS. 8A-8B.

In some embodiments, the bracket assembly 100′ differs from the bracket assembly 100 described herein by having an alternative configuration for the pivot location 121′ between the clamp members 120 and the base member 110′. As shown in FIGS. 8A-8B, in some embodiments, instead of having adjacent slotted recesses 112a, 112b, the base member 110′ may have adjacent apertures 122a′, 122b′. Similar to the slotted recesses 112a, 112b described herein, the adjacent apertures 122a′, 122b′ are configured to receive a shaft member 102, 102′ which will allow the clamp members 120 to rotate (or pivot) relative to the base member 110′.

Also, similar to the slotted recesses 112a, 112b, the adjacent apertures 122a, 122b′ allow the pivot location 121′ between the clamp members 120 and the base member 110′ to be adjustable, thereby allowing the bracket assembly 100′ to accommodate different sizes of first members 22, 22′ (e.g., horizontal members) and/or second members 24, 24′ (e.g., vertical members) (e.g., range of diameters D1, D2). In other words, the shaft member 102, 102′ may be inserted through the respective inner apertures 122a′ in the base member 110′ to accommodate members 22′, 24′ having a smaller diameter (e.g., D2) or inserted through the respective outer apertures 122b′ in the base member 110′ to accommodate members 22, 24 having a larger diameter (e.g., D1). In some embodiments, the shaft member 102, 102′ may be similar to the shaft member 102 described with respect bracket assembly 100 (see, e.g., FIG. 2B).

In some embodiments, the bracket assembly 100′ may comprise an alternative shaft member 102′. For example, as further shown in FIGS. 8A-8B, in some embodiments, the alternative shaft member 102′ is a clevis pin type fastener in which the shaft member 102′ has an aperture 102a′ configured to receive a pin fastener 108. After the shaft member 102′ is inserted through a respective aperture 122a′, 122b′ in the base member 110′, the pin fastener 108 is received through the aperture 102a′ in the shaft member 102′ to secure the clamp member 120 to the base member 110′ and form the pivot location 121′ therebetween.

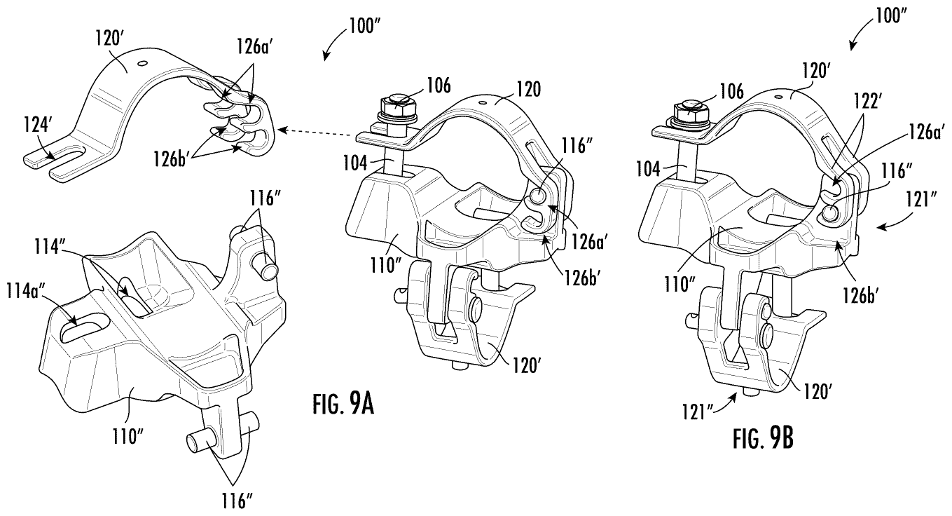

Referring now to FIGS. 9A-9B, another alternative bracket assembly 100″ according to embodiments of the present invention is illustrated. Properties and/or features of the bracket assembly 100″ may be as described above in reference to the bracket assemblies 100, 100′ described herein and duplicate discussion thereof may be omitted herein for the purposes of discussing FIGS. 9A-9B.

In some embodiments, the bracket assembly 100″ differs from the bracket assemblies 100, 100′ described herein by having an alternative configuration for the pivot location 121″ between the clamp members 120′ and the base member 110″. As shown in FIGS. 9A-9B, in some embodiments, the shaft member 102, 102′ of the bracket assemblies 100, 100′ described herein is replaced with protrusion members 116″ coupled to and extending outwardly from the base member 110″. As described in further detail below, the protrusion members 116″ are configured to engage with an end of the clamp members 120″ to form the respective pivot locations 121″ between the clamp members 120″ and the base member 110″.

As shown in FIGS. 9A-9B, in some embodiments, a pair of arms 122′ reside at the end of each clamp member 120′. The pair of arms 122′ are spaced apart from each other and extending outwardly from the end of the respective clamp member 120′. In some embodiments, each arm 122′ comprises two pairs of hooks or like features 126a′, 126b′. The pairs of hooks 126a′, 126b′ are configured to engage with the protrusion members 116″ extending from the base member 110″ to form the respective pivot locations 121″ between the clamp members 120′ and the base member 110″. As further shown in FIGS. 9A-9B, similar to the clamp members 120 described herein, in some embodiments, the opposing ends of each clamp member 120′ comprise a recess 124′ that is configured to receive a respective fastener 104 (e.g., a T-type swing bolt or ball-ended fastener) that is configured to secure the corresponding clamp member 120′ in a closed position.

As shown in FIGS. 9A-9B, in some embodiments, the inner and outer pairs of hooks 126b′, 126a′ of the respective clamp members 120′ are configured to engage with corresponding protrusion members 116″ on the base member 110″. According to embodiments of the present invention, the pairs of hooks 126a′, 126b′ of the clamp members 120′ and protrusion members 116″ in the base member 110′ may function in a similar manner as the shaft members 102, 102′ and slotted recesses 112a, 112b or apertures 122a′, 122b′ for the bracket assembly 100, 100′ described herein to allow the respective pivot locations 121″ between the clamp members 120′ and the base member 110″ to be adjustable, thereby allowing the bracket assembly 100″ to accommodate different sizes of first (e.g., horizontal) members 22, 22′ and/or second (e.g., vertical) members 24, 24′ (e.g., range of diameters D1, D2). For example, in some embodiments, the inner pair of hooks 126b′ of the respective clamp members 120′ are configured to engage with respective protrusion members 116″ extending from the base member 110″ to accommodate members 22′, 24′ having a smaller diameter (e.g., D2) or the outer pair of hooks 126a′ of the clamp members 120′ are configured to engage with the protrusion members 116″ to accommodate members 22, 24 having a larger diameter (e.g., D1).

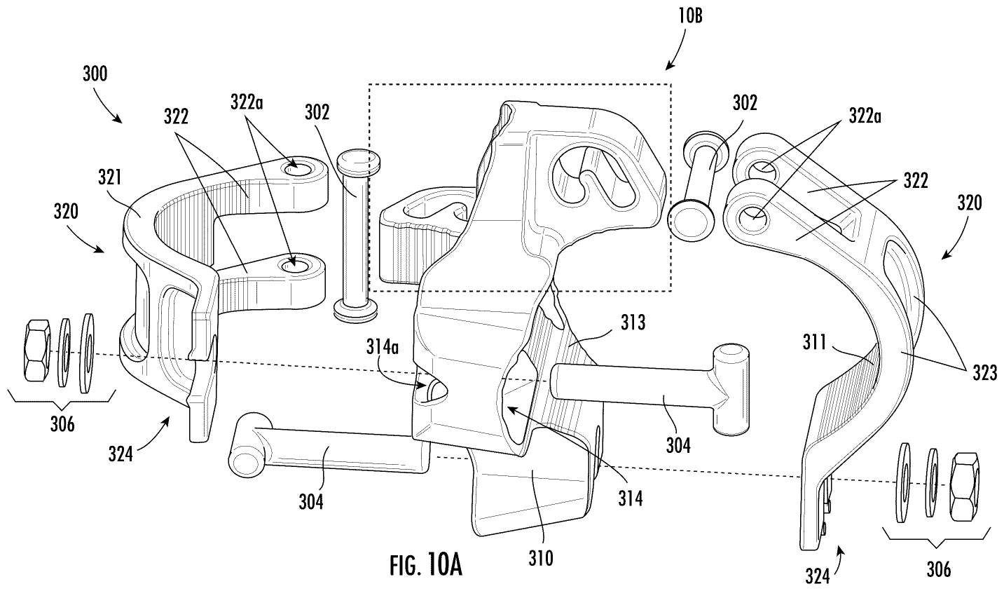

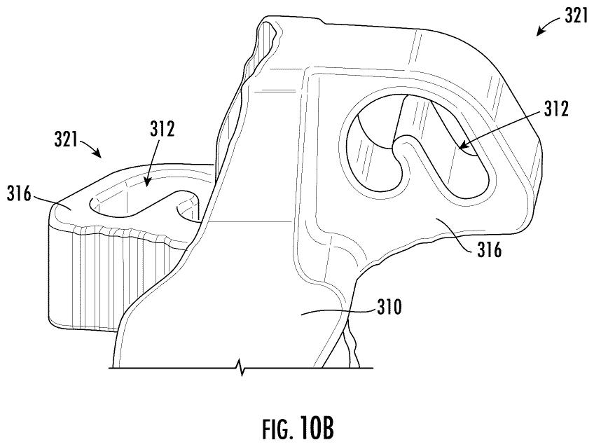

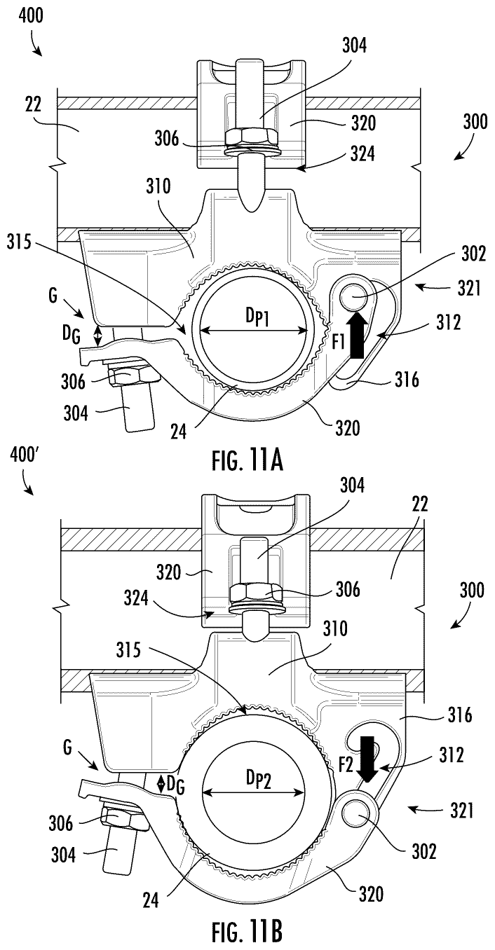

Referring now to FIGS. 10A-10B and FIGS. 11A-11B, another alternative bracket assembly 300 and corresponding antenna mount assemblies 400, 400′ according to embodiments of the present invention is illustrated. Properties and/or features of the bracket assembly 300 and antenna mount assemblies 400, 400′ may be as described above in reference to the bracket assemblies 100, 100′, 100″ and/or antenna mount assemblies 200, 200′ described herein and duplicate discussion thereof may be omitted herein for the purposes of discussing FIGS. 10A-10B and FIGS. 11A-11B.

As shown in FIG. 10A, in some embodiments, the bracket assembly 300 comprises a base member 310 and two clamp members 320. The clamp members 320 are each coupled to opposing sides of the base member 310 and configured to secure a first (e.g., horizontal) member 22 or a second (e.g., vertical) member 24 therebetween (see, e.g., FIGS. 11A-11B). Similar to the other bracket assemblies 100, 100′, 100″ described herein, in some embodiments, one or more of the components of the bracket assembly 300 may be formed from a metallic material (e.g., steel). In some embodiments, one or more of the metallic components of the bracket assembly 300 may be further cladded or covered with a polymeric coating (e.g., rubber or plastic) to help minimize any passive intermodulation (PIM) that could be created from the metal-to-metal contacts between the bracket assembly 300 and the members 22, 24 (e.g., in the antenna mount assemblies 400, 400′ shown in FIGS. 11A-11B). In other embodiments, one or more of the components of the bracket assembly 300 may be formed from a non-metallic (e.g., polymeric) material, thereby reducing the metal-to-metal contacts and further helping to minimize PIM.

In some embodiments, each clamp member 320 is pivotably coupled to the base member 310. As discussed further below, the bracket assembly 300 differs from the bracket assemblies 100, 100′, 100″ described herein in that the bracket assembly 300 has an alternative configuration for the pivot location 321 between the clamp members 320 and the base member 310. Each clamp member 320 has a main body 321. In some embodiments, the main body 321 has opposing side walls 323 that outwardly therefrom. In some embodiments, a shaft member 302 (e.g., a pin, a rod or like member) resides at an end of each clamp member 320. In some embodiments, the shaft member 302 may define the pivot location 321 with the base member 310. In some embodiments, a pair of arms 322 reside at the end of the main body 321 of each clamp member 320. In some embodiments, the pair of arms 322 are spaced apart from each other and extend outwardly from the end of the respective clamp member 320. In some embodiments, each arm 322 comprises an aperture 322a configured to receive the shaft member 302 therethrough. In other embodiments, the shaft member 302 may be integrally formed with the end of each clamp member 320 and extends between the pair of arms 322.

The shaft member 302 is configured to engage with the base member 310 to form the pivot location 321 between the clamp member 320 and the base member 110 which will allow the clamp member 320 to be moved (i.e., rotated or pivoted) to an opened position such that a respective member (i.e., first or second member 22, 24) may be positioned in an opening 315 between the clamp member 320 and the base member 310. As shown in FIG. 10A, in some embodiments, the opposing end of the main body 321 of each clamp member 320 comprises a recess 324. Each recess 324 is configured to receive a respective fastener 304 that is configured to secure the corresponding clamp member 320 in a closed position (i.e., once the respective member 22, 24 has been positioned in the opening 315 between the clamp member and the base member 310) (see, e.g., FIGS. 11A-11B).

As shown in FIGS. 10A-10B, in some embodiments, the base member 310 comprises a pair of arcuate slots 312. In some embodiments, the arcuate slots 312 may have a “U” or “J” shape. In some embodiments, arcuate slots 312 reside on opposing sides of the base member 310. In some embodiments, the arcuate slots 312 reside in arms 316 extending outwardly from the base member 310. Each arcuate slot 312 is configured to receive a respective shaft members 302 (i.e., allow the clamp members 320 to engage with the base member 310) to form the pivot locations 321 with the respective clamp member 320. As described in further detail below, in some embodiments, the shaft members 302 are configured to slide within their respective arcuate slot 312 allow the position of the respective pivot locations 321 between the clamp members 320 and the base member 310 to be adjusted, thereby allowing bracket assembly 300 to accommodate different sizes (e.g., diameters D_{P1}, D_{P2}) of first and/or second members 22, 24 (see, e.g., FIGS. 11A-11B). In addition, as shown in FIGS. 10A-10B, unlike the slotted recesses 112a, 112b of the bracket assembly 100, the arcuate slots 312 of the bracket assembly 300 are “internal” (i.e., do not have an opening end) which secures the shaft member 302 of the clamp member 320 within the slot 312 while still allowing movement of the shaft member 302 (and clamp member 320), and thus prevents the clamp member 320 from being dropped from the bracket assembly 300 during installation.

Still referring to FIG. 10A, in some embodiments, the base member 310 further comprises a pair of housing cavities 314, each housing cavity 314 each having a corresponding aperture 314a. Each cavity 314 and corresponding aperture 314a is configured to receive a respective fastener 304. As discussed above, in some embodiments, each fastener 304 is configured engage with a respective clamp member 320 to secure the clamp member 320 in a closed position relative to the base member 310 to secure a respective first member 22 or second member 24 therebetween (see, e.g., FIGS. 11A-11B). As shown in FIG. 10A, in some embodiments, the fasteners 304 may be T-type swing bolts. In other embodiments, the fasteners 304 may be ball-ended fasteners. In some embodiments, the cross-end of the T-bolt fastener 304 (or ball of the ball-ended fastener) is configured to be held within the housing cavity 314 of the base member 310 as the opposing end extends through the corresponding aperture 314a to engage and be secured to the corresponding clamp member 320 via coupling components 306, e.g., washers and a nut.

In some embodiments, each clamp member 320 may have an arcuate or convex shape or profile and the corresponding sides of the base member 310 may have an arcuate or concave recess or profile 313. As discussed above, each clamp member 320 and base member 310 together define an opening 315 configured to receive the respective member 22, 24 therebetween (see also, e.g., FIGS. 11A-11B). In some embodiments, the configurations of the clamp members 320 and corresponding sides of the base member 310 (i.e., corresponding convex and concave profiles) allow for the bracket assembly 300 to have larger contact surface areas to engage with the outer diameters of the respective member 22, 24 held therebetween, i.e., when the clamp members 320 are pivoted into the closed position relative to the base member 310. In some embodiments, the inner surfaces of the clamp members 320 and/or the corresponding surfaces of the base member 310 may comprise protrusions or other like features 313 configured to help grip a respective member 22, 24 held therebetween.

A first (e.g., horizontal) member 22 and a second (e.g., vertical) member 24 may be secured together using the bracket assembly 300 in a similar manner as described herein and illustrated in FIGS. 6A-6E. For example, the shaft member 302 of the clamp members 320 are positioned at a desired location within the respective arcuate slots 312 of the base member 310, and the clamp members 320 are pivoted relative to the base member 310 (about pivot locations 321) and the opposing ends of the clamp members 320 are secured to the base member 320 via the fasteners 304 and coupling components 306, thereby securing the respective member 22, 24 therebetween. As noted above, the shaft member 302 is held within the “internal” arcuate slot 312, and thus cannot be dropped from the bracket assembly 300 during installation.

As shown in FIGS. 11A-11B, the location that the shaft member 302 is positioned within the slots 312 may be changed depending on the size (e.g., diameter) of the corresponding vertical member 22, 24. For example, as shown in FIG. 11A, when the member 22, 24 has a first diameter D_{P1}, the shaft member 302 may be moved (slide) within the arcuate slot 312 in a first direction F1 (e.g., toward the base member 310) such that the shaft member 302 is positioned closer to the base member 310 within the slot 312. As shown in FIG. 11B, when the member 22, 24 has a second diameter D_{P2}, the shaft member 302 may be moved (slide) within the arcuate slot 312 is a second opposing direction F2 (e.g., away from the base member 310) such that the shafter member 302 is positioned further from the base member 310 within the slot 312. In some embodiments, the second diameter of the member 22, 24 is larger than the first diameter of the member 22, 24. In some embodiments, the shaft member 302 is moved in the first direction F1 within the slot 312 (as shown in FIG. 11A) to accommodate a member 22, 24 having a first diameter D_{P1} of about 2.375 inches. In some embodiments, the shaft member 302 is moved in the second direction F2 within the slot 312 (as shown in FIG. 11B) to accommodate a member 22, 24 having a second diameter D_{P2} of about 2.875 inches.

When the fastener 304 is positioned within the recess 324 of the clamp member 320, and the corresponding coupling components 306 are tightened thereon to secure the end of the clamp member 320 to the base member 310 in a closed and locked position, a gap G may exist between the end of the clamp member 320 and the base member 310. As further shown in FIGS. 11A-11B, in some embodiments, the distance D_{G} of the gap G may be approximately equal irrespective of the diameter D_{P1}, D_{P2} of the members 22, 24 held between the clamp member 320 and the base member 310. In other words, in some embodiments, the distance D_{G} between the base member 310 and the end of the clamp member 320 will be approximately the same when the member 22, 24 held therebetween has a first diameter D_{P1} or a second (larger) diameter D_{P2}.

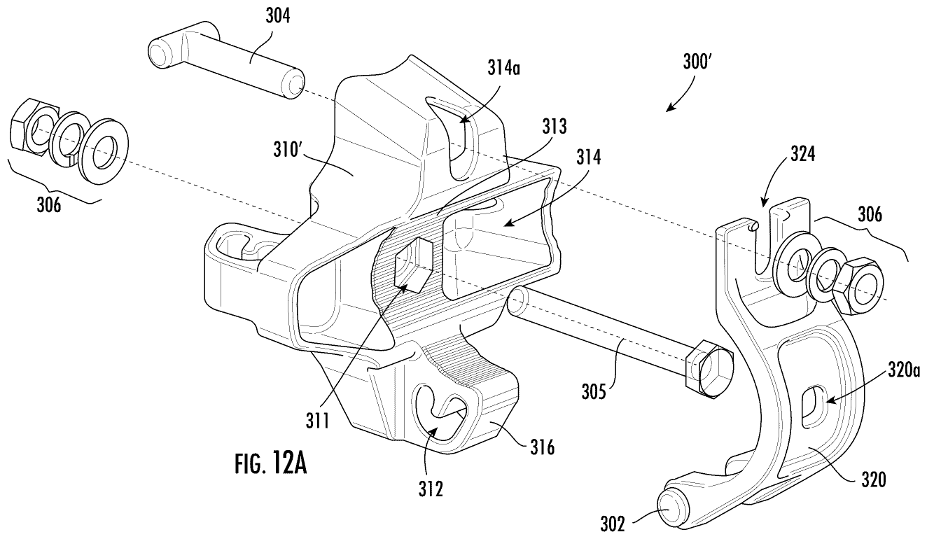

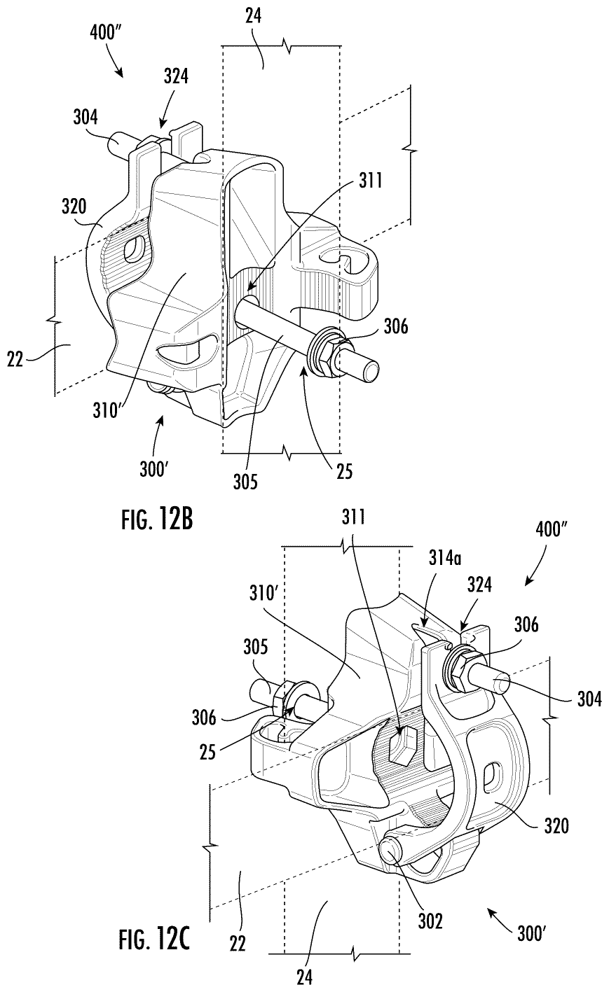

Referring now to FIGS. 12A-12C, another bracket assembly 300′ and corresponding antenna mount assembly 400″ according to embodiments of the present invention is illustrated. The bracket assembly 300′ provides an alternative configuration for the bracket assembly 300 described herein. Accordingly, properties and/or features of the bracket assembly 300′ and antenna mount assembly 400″ may be as described above in reference to the bracket assembly 300 and/or antenna mount assembly 400′ described herein and duplicate discussion thereof may be omitted herein for the purposes of discussing FIGS. 12A-12C.

As shown in FIGS. 12A-12C, in some embodiments, the bracket assembly 300′ differs from the bracket assembly 300 described herein in that at least one of the clamp members 320 (e.g., the clamp member 320 that would be configured to engage with the vertical member 24) is replaced with a fastener 305 to secure the bracket assembly 300′ to the respective member 22, 24.

In some embodiments, the base member 310′ of the bracket assembly 300′ comprises a central aperture 310′ extending therethrough. The central aperture 310′ may be configured to receive the fastener 305 to secure the bracket assembly 300′ to a respective member 22, 24. In some embodiments, the fastener 305 may be a hex bolt or other like fastener. In some embodiments, the fastener 305 is configured to be inserted through a corresponding hole 25 in the respective member 22, 24. The fastener 305 is tightened with coupling components 306 (e.g., washers and a nut), thereby securing the bracket assembly 300′ to the respective member 22, 24 (see also, FIGS. 12B-12C). In some embodiments, the fastener 305 replaces the clamp member 320 that secures the bracket assembly 300′ to the vertical member 24. As shown in FIGS. 12B-12C, the bracket assembly 300′ further comprises a clamp member 320 to secure the bracket assembly 300′ to the other (e.g., the horizontal) member 22 in a similar manner as described herein with respect to bracket assembly 300.

In addition, similar to the bracket assembly 100 described herein, in some embodiments, the clamp member 320 may comprise an additional aperture 320a. In some embodiments, the additional aperture 320a may reside in a generally central location between the opposing ends of the clamp member 320. In some embodiments, the additional aperture 320a may be configured to receive a fastener (not shown) that will engage or contact the respective member 22, 24 held between the clamp member 320 and the base member 310 (see, e.g., FIG. 4B). In some embodiments, the fastener may help to further secure the respective member 22, 24 between the clamp member 320 and the base member 310 and may also help to minimize longitudinal movement of the respective members 22, 24 relative to the bracket assembly 300′. In some embodiments, the aperture 320a may also be used as an indicator to help locate a position on the respective member 22, 24 where the clamp member 320 should be secured. For example, in some embodiments, the aperture 320a may be used as a visual “window” to help locate a positioning mark on the respective member 22, 24 which identifies the location to secure the clamp member 320.

FIGS. 12B-12C show another antenna mount assembly 400″ according to embodiments of the present invention in which the bracket assembly 300′ is secured to a vertical member 24 with a fastener 305 and is secured to a horizontal member 22 with a clamp member 320. It is noted that, while not shown, in some embodiments, it is possible for the bracket assembly 300′ to be secured to the vertical member 22 with a clamp member 320 and to the horizontal member 22 with a fastener 305.

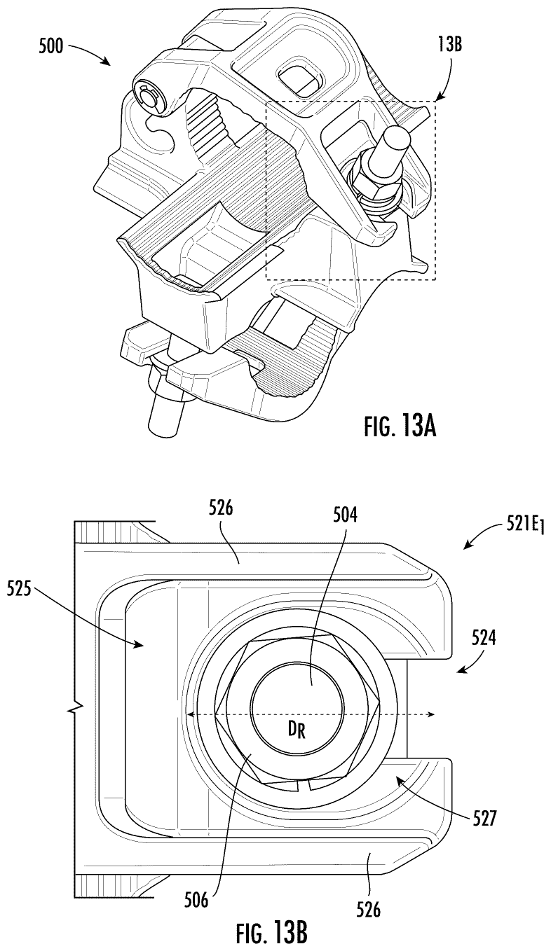

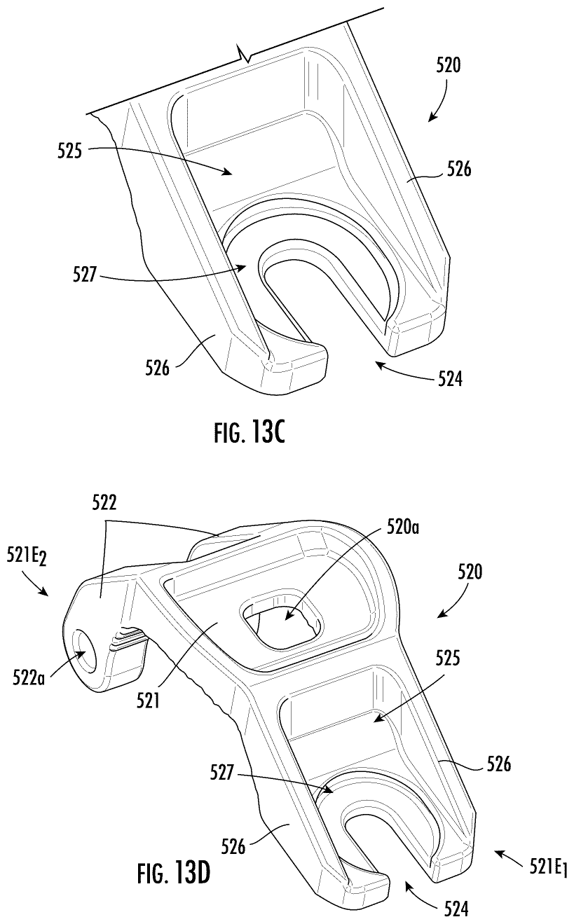

Referring now to FIGS. 13A-19B, an alternative bracket assembly 500 according to embodiments of the present invention is illustrated. Properties and/or features of the mounting bracket 500 may be as described above in reference to the bracket assemblies 100, 100′, 100″, 300, 300′ described herein and duplicate discussion thereof may be omitted herein for the purposes of discussing FIGS. 13A-19B.

FIGS. 13A-13D and FIGS. 14A-14B illustrate one of the clamp members 520 of the bracket assembly 500 according to embodiments of the present invention. Each clamp member 520 has a main body 521 having opposing ends 521E₁, 521E₂. FIGS. 13A-13D show an alternative configuration to the end 521E₁ of the clamp members 520 comprising the recess 524. Similar to the other bracket assemblies described herein, the recess 524 in each clamp member 502 is configured to receive a respective fastener 504 to secure the clamp member 520 in a closed position (e.g., when a respective member 22, 24 has been positioned between the respective clamp member 520 and the base member 510). It should be noted that this alternative configuration to the end 521E₁ of the clamp members 520 may be incorporated into any of the bracket assemblies described herein.

In some embodiments, the end 521E₁ of each clamp member 520 may comprise a second recess or indentation 527 in an upper surface of the clamp member 520. As shown in FIGS. 13B-13D, the second recess or indentation 527 resides around the recess 524. In some embodiments, the recess or indentation 527 is configured to receive at least a portion of the coupling components 506 (e.g., washers and a nut) that engages the fastener 504 when received within the recess 524. In some embodiments, the second recess or indentation 527 may have an oblong or elliptical shape which provides flexibility and allows the hardware (i.e., fastener 504 and corresponding coupling components 506) to move a distance D_{R} within the recess 524 while at the same time remaining contained therein, and thus, maintains the clamp member 520 being secured to the base member 510 (see, e.g., FIG. 13B). For example, in some embodiments, the second recess or indentation 527 may allow the hardware (fastener 504 and corresponding coupling components 506) to move a distance D_{R} within the recess 524 up to about 5 millimeters.

As further shown in FIGS. 13B-13D, in some embodiments, the end 521E₁ of each clamp member 520 may comprise opposing ribs or side walls 526 extending upwardly therefrom. The opposing ribs or side wall 526 may be positioned on opposing sides of the recess 524 (and the second recess or indentation 527). In other words, the recess 524 (and second recess 527) are positioned between the opposing ribs or side walls 526. The opposing ribs or side walls 526 may provide additional support or reinforcement to the clamp member 520, for example, when the respective member 22, 24 is secured between the clamp member 520 and the base member 510. In some embodiments, the opposing ribs or side walls 526 may partially define a cavity 525 at the end 521E₁ of the clamp member 520. In some embodiments, when the clamp member 520 is secured in the closed position, the end of the respective fastener 504 (and corresponding coupling component 506) will be positioned within the cavity 525 (see, e.g., FIGS. 13A-13B).

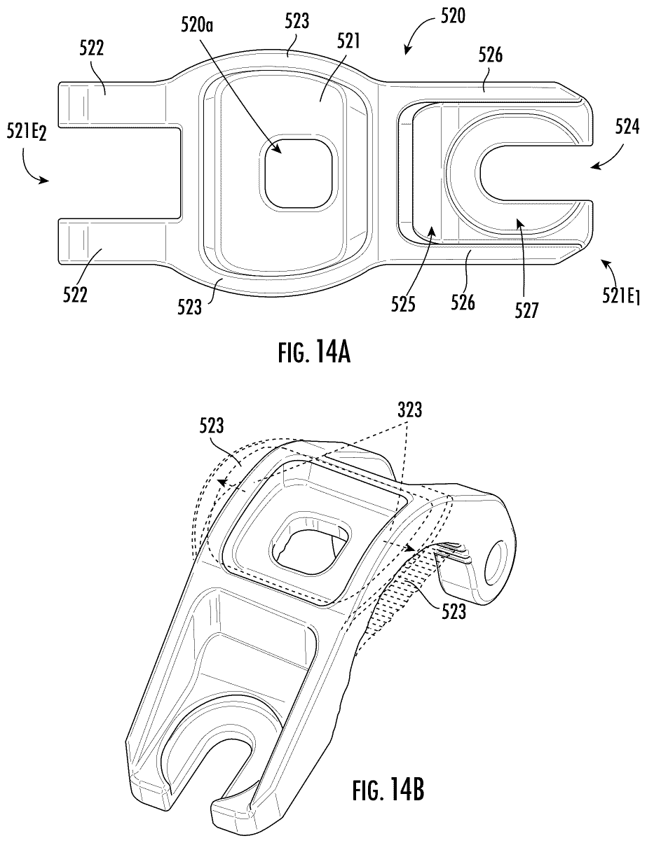

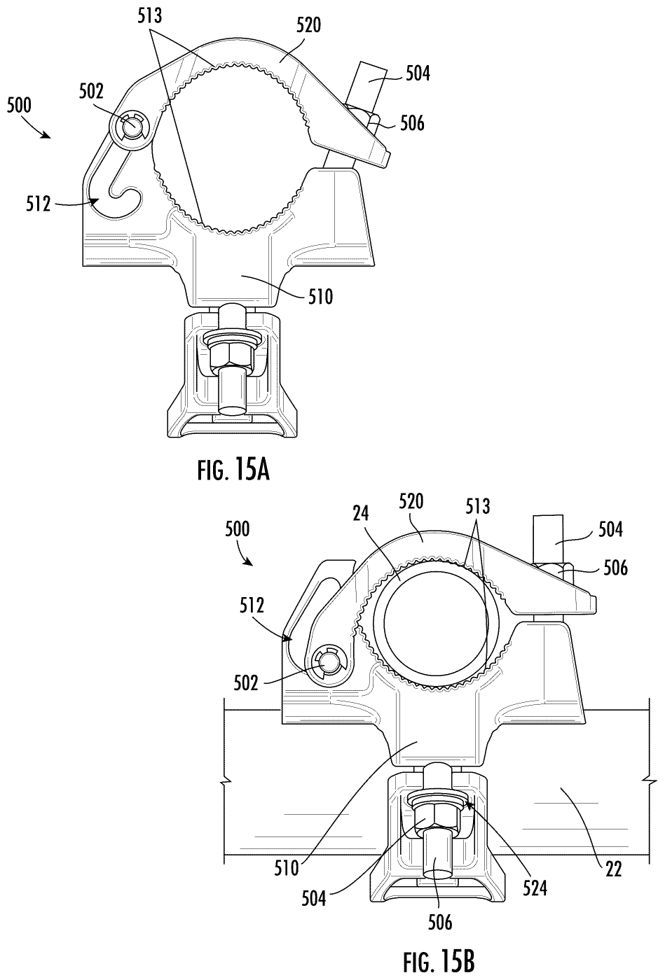

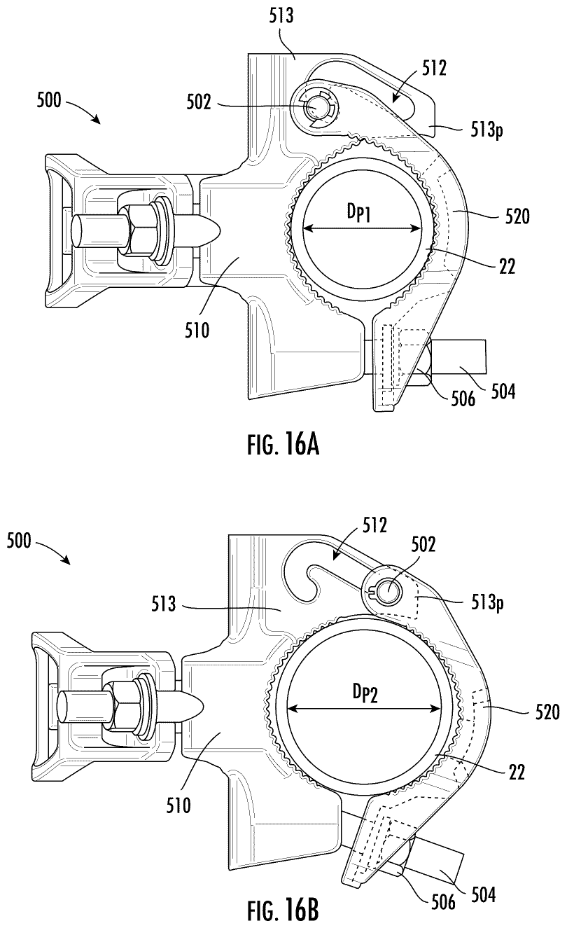

As shown in FIG. 13D, similar to other clamp members of the bracket assemblies described herein, a pair of arms 522 may reside at the opposing end 521E₂ of each clamp member 520 (i.e., opposite from the recess 524). In some embodiments, the pair of arms 522 are spaced apart from each other and extend outwardly from the end 521E₂ of the respective clamp member 520. In some embodiments, each arm 522 comprises an aperture 522a configured to receive the shaft member 502 therethrough (see, e.g., FIGS. 15A-15B and FIGS. 16A-16B). In other embodiments, the shaft member 502 may be integrally formed with the end 521E₂ of each clamp member 520 and extends between the pair of arms 522.

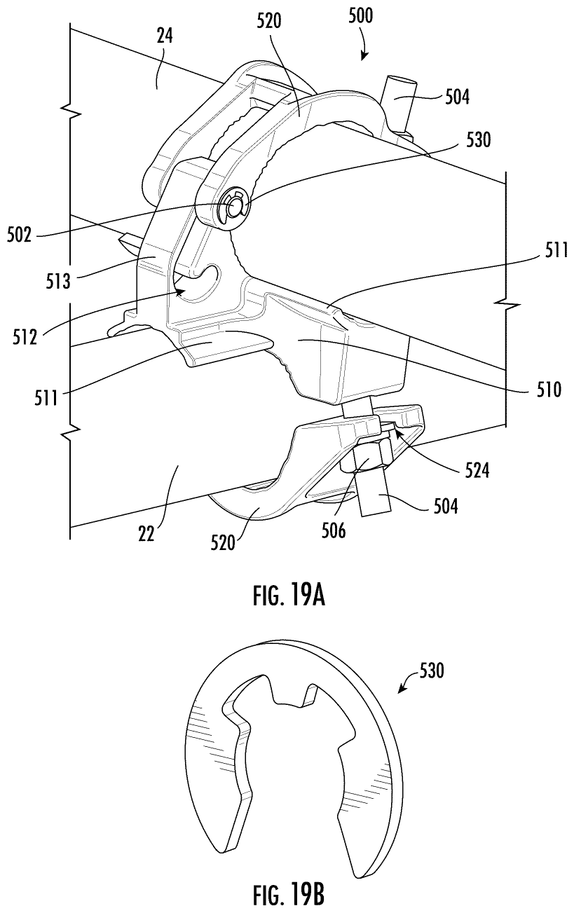

As further shown in FIG. 13D, similar to other clamp members of the bracket assemblies described herein, in some embodiments, the main body 521 of the clamp member 520 may comprise an additional aperture 520a (see also FIG. 14A). In some embodiments, the additional aperture 520a may reside in a generally central location of the main body 521 between the opposing ends 521E₁, 521E₂ of the clamp member 520. In some embodiments, the additional aperture 520a may be configured to receive a fastener (not shown) that will engage or contact the respective member 22, 24 held between the clamp member 520 and the base member 510 (see, e.g., FIG. 19A). In some embodiments, the fastener may help to further secure the respective member 22, 24 between the clamp member 520 and the base member 510 and may also help to minimize longitudinal movement of the respective members 22, 24 relative to the bracket assembly 500. In some embodiments, the aperture 520a may also be used as an indicator to help locate a position on the respective member 22, 24 where the clamp member 520 should be secured. For example, in some embodiments, the aperture 520a may be used as a visual “window” to help locate a positioning mark on the respective member 22, 24 which identifies the location to secure the clamp member 520.

FIGS. 14A-14B show a modification to the main body 521 of the clamp member 520 in which additional material may be added to the clamp member 520, according to embodiments of the present invention. As shown in FIGS. 14A-14B, in some embodiments, the additional material may be added to opposing side walls 523 extending upwardly from a generally central location of the main body 521. In some embodiments, the aperture 521a in the main body 521 may reside between the opposing side walls 532. In some embodiments, the opposing side walls 523 may have a convex shape (i.e., the side walls 523 bulge outwardly relative to the rest of the main body 521). FIG. 14B illustrates the convex shape of the opposing side walls 523 compared to the straighter side walls 323 of the clamp member 320 for the bracket assembly 300 described herein (see also FIG. 10A). In some embodiments, the additional material (and convex shape) of the opposing side walls 523 help to strengthen and provide additional structural support to the respective clamp members 520.

As described herein, in some embodiments, the bracket assemblies comprise protrusions or other like features 313 (e.g., teeth) on the inner surfaces of main body 321 of the clamp members 320 and/or the corresponding surfaces of the base member 310 that are configured to help grip a respective member 22, 24 held therebetween. Referring to FIGS. 15A-15B, according to embodiments of the present invention, the inner surfaces the main body 521 of the clamp members 520 and/or corresponding surfaces of the base member 510 for bracket assembly 500 may include a greater number of protrusions, teeth, or like features 513 (compared with the bracket assemblies described herein. As shown in FIG. 15B, in some embodiments, the inclusion of more protrusions 513 on the inner surfaces the main body 521 of the clamp members 520 and/or corresponding surfaces of the base member 510 may help provide a better, more secure, grip on the respective member 22, 24 held therebetween.

Referring to FIGS. 16A-16B, a modification to the base member 510 according to embodiments of the present invention, is illustrated. As described herein, in some embodiments, the bracket assembly of the present invention may comprise opposing arms extending outwardly from the base member (for example, in bracket assembly 300 illustrated in FIG. 10B, the arcuate slots 312 reside in respective arms 316 that extend outwardly from the base member 310). Similarly, as shown in FIGS. 16A-16B, in some embodiments, the bracket assembly 500 comprises arcuate slots 512 that may reside within respective arms 516 extending outwardly from the base member 510.

As further shown in FIGS. 16A-16B, in some embodiments, the arms 516 differ from the arms 316 described herein, in that the arms 516 may comprise a protruding end 513p. In some embodiments, the protruding end 513p may curve slightly inward relative to the arm 516 (i.e., toward the respective member 22, 24). In some embodiments, the protruding end 513p may provide additional support to hold different diameter (D_{P1}, D_{P2}) horizontal and/or vertical members 22, 24 to the bracket assembly 500. In some embodiments, the protruding end 513p may help retain a horizontal member 22 within the bracket assembly 500. For example, the protruding end 513p may help retain the corresponding horizontal member 22 for an assembled pipe system (e.g., sector frame 20 shown in FIG. 1) within the bracket assembly 500, even when the corresponding clamp member 520 is in an open position. In some embodiments, the protruding end 513p may allow an installer to rest an assembled pipe system on a horizonal member 22 (and move into a desired position), then move the corresponding clamp member 520 into a closed position to secure the horizontal member 22 within the bracket assembly 500. In some embodiments, even if the clamp member 520 is in the closed position, the fastener 504 may be loosened slightly and the assembled pipe system could be moved into the desired position, while the protruding end 513p helps retain the corresponding horizontal member 22 within the bracket assembly 500.

FIG. 16A illustrates the bracket assembly 500 secured to a horizontal member 22 having a first diameter D_{P1}. In some embodiments, the horizontal member 22 (or vertical member 24) may have a first diameter D_{P1} of about 2.375 inches. FIG. 16B illustrates the bracket assembly 500 secured to a horizontal member 22 having a second larger diameter D_{P2}. In some embodiments the horizontal member 22 (or vertical member 24) may have a second diameter D_{P2} of about 2.875 inches.

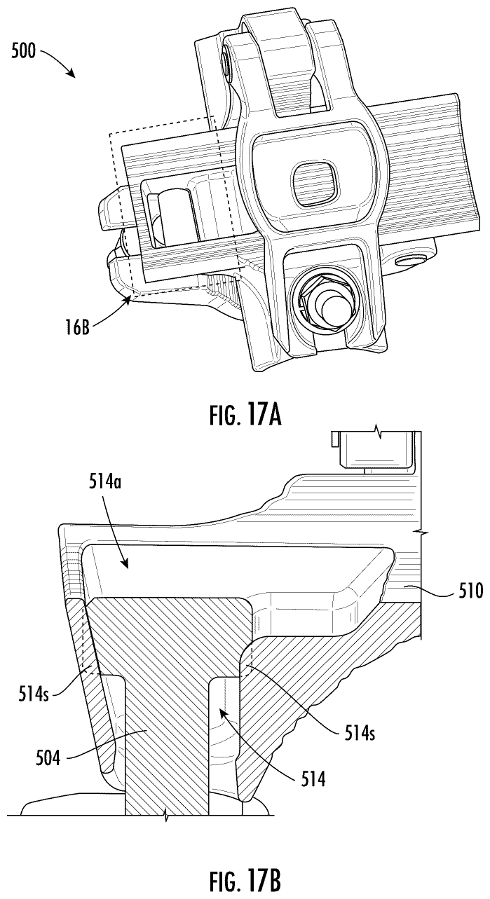

FIGS. 17A-17B illustrate a modification to the housing cavities 514 of the base member 510 for the bracket assembly 500 according to embodiments of the present invention. Similar to the bracket assemblies described herein, in some embodiments, the base member 510 of bracket assembly 500 may comprise a pair of housing cavities 514, each housing cavity 514 each having a corresponding aperture 514a. FIG. 17B shows an enlarged partial view of one of the housing cavities 514 of the base member 510. Each cavity 514 and corresponding aperture 514a is configured to receive a respective fastener 504. As described herein, in some embodiments, each fastener 504 is configured engage with a respective clamp member 520 to secure the clamp member 520 in a closed position relative to the base member 510 to secure a respective first member 22 or second member 24 therebetween (see FIG. 19A).

As shown in FIG. 17B, in some embodiments, the fasteners 504 may be T-type swing bolts. In other embodiments, the fasteners 504 may be ball-ended fasteners. In some embodiments, the cross-end of the T-bolt fastener 504 (or ball of the ball-ended fastener) is configured to be held within the housing cavity 514 of the base member 510 as the opposing end extends through the corresponding aperture 514a to engage and be secured to the corresponding clamp member 520 via coupling components 506, e.g., washers and a nut.

As further shown in FIG. 17B, in some embodiments, each housing cavity 514 may comprise opposing shoulders or protrusions 514s. In some embodiments, the shoulders 514s may be configured to engage and/or receive at least a portion of the cross-end of the T-bolt fastener (or ball of the ball-ended fastener) 504, thereby preventing the fastener 504 from rotating within the housing cavity 514.

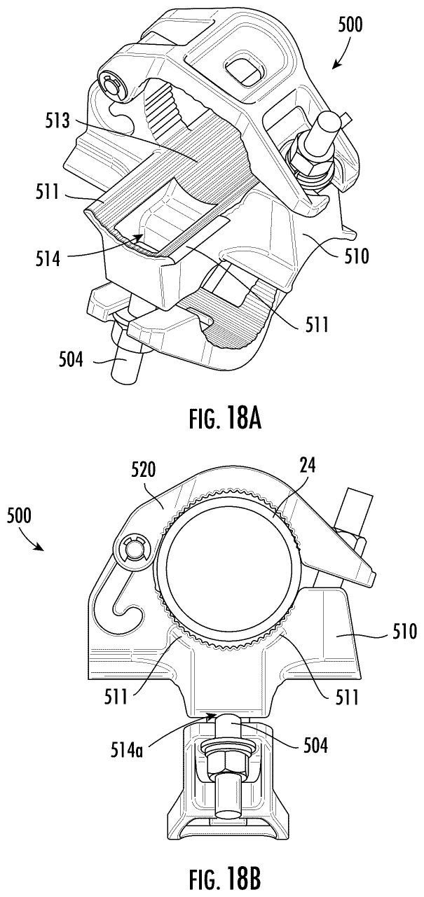

Referring to FIGS. 18A-18B, in some embodiments, the base member 510 may comprise flanged edges 511 residing on opposing sides of each housing cavity 514. In some embodiments, the flanged edges 511 may have an arcuate profile. As shown in FIG. 18B, the arcuate profile allows the flanged edges 511 to further engage/contact the respective first member 22 or second member 24 secured between the base member 520 and the corresponding clamp member 520. The flanged edges 511 may provide additional strength and structural support to the bracket assembly 500. In some embodiments, the flanged edges 511 may also provide better securement of the bracket assembly 500 with the members 22, 24. For example, as shown in FIGS. 18A-18B, in some embodiments, the protrusions, teeth, or like features 513 on the inner surface of the base member 510 may continue to extend along the flanged edges 511 to help further provide a better, more secure, grip on the respective member 22, 24 held between the base member 510 and the corresponding clamp member 520.

Referring to FIGS. 19A-19B, in some embodiments, the bracket assembly 500 may comprise one or more locking mechanisms 530. As shown in FIG. 19A, in some embodiments, each locking mechanism 530 may be configured to engage with a respective shaft member 502 to secure the shaft member 502 in position within the corresponding slot 512, for example, when the clamp member 520 is in the closed position relative to the base member 510 to secure a respective member 22, 24 therebetween. As shown in FIG. 19B, in some embodiments, the locking mechanisms 530 may be an E-clip or similar type of retaining ring.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A bracket assembly, the bracket assembly comprising:
a base member;
a first clamp member coupled to a first side of the base member at a first location; and
a second clamp member coupled to an opposing second side of the base member at a second location,
wherein the bracket assembly is configured to secure a first member between the first clamp member and the base member and configured to secure a second member between the second clamp member and the base member, and
wherein the first and second locations are configured to be adjustable to accommodate first and/or second members having different diameters.

2. The bracket assembly according to claim 1, wherein the first member extends generally parallel to a ground plane and the second member extends generally perpendicular to the ground plane, and wherein the bracket assembly secures the first member to the second member at a cross-over point between the first and second members.

3. The bracket assembly according to claim 1, wherein the first and second clamp members are pivotably coupled to the base member, a shaft member resides at an end of each clamp member, each shaft member defining a respective pivot location with the base member, and wherein the end of each clamp member comprises a pair of spaced apart arms extending outwardly therefrom, the shaft member extending between the arms.

4. The bracket assembly according to claim 3, wherein an opposing end of each clamp member comprises a recess, each recess configured to receive a respective fastener to secure the corresponding clamp member in a closed position relative to the base member.

5. The bracket assembly according to claim 3, wherein the base member comprises one or more slots, the one or more slots configured to receive the respective shaft members of the first and second clamp members to form the respective pivot locations with the base member.

6. The bracket assembly according to claim 1, wherein the base member comprises a pair of housing cavities each having an aperture, each cavity and corresponding aperture configured to receive a respective fastener configured to engage with a respective clamp member to secure the clamp members in closed position relative to the base member.

7. The bracket assembly according to claim 1, wherein each clamp member has a convex shape and the corresponding sides of the base member have a concave recess, and wherein each clamp member and the base member together define a respective opening configured to receive the first or second member therebetween.

8. The bracket assembly according to claim 1, wherein each clamp member comprises an aperture configured to receive a fastener that will engage contact the respective first or second member to further secure the respective first or second member between the clamp member and the base member.

9. A mount assembly, the mount assembly comprising:
a horizontally-extending member;
a vertically-extending member; and
a bracket assembly, the bracket assembly comprising:
a base member;
a first clamp member coupled to a first side of the base member at a first location; and
a second clamp member coupled to an opposing second side of the base member at a second location,
wherein the horizontally-extending member is secured between the first clamp member and the base member,
wherein the vertically-extending member is secured between the second clamp member and the base member, and
wherein the first and second locations are configured to be adjustable to accommodate a horizontally-extending member having a first diameter and a vertically-extending member having a second diameter.

10. The mount assembly according to claim 9, wherein a shaft member resides at an end of each clamp member, each shaft member defining a respective pivot location with the base member, and wherein the end of each clamp member comprises a pair of spaced apart arms extending outwardly therefrom, the shaft member extending between the arms.

11. The mount assembly according to claim 10, wherein an opposing end of each clamp member comprises a recess, each recess configured to receive a respective fastener to secure the corresponding clamp member in a closed position relative to the base member.

12. The mount assembly according to claim 10, wherein the base member comprises one or more slots, the one or more slots configured to receive the respective shaft members of the first and second clamp members to form the respective pivot locations with the base member.

13. The mount assembly according to claim 9, wherein the base member comprises a pair of housing cavities each having an aperture, each cavity and corresponding aperture configured to receive a respective fastener configured to engage with a respective clamp member to secure the clamp members in closed position relative to the base member.

14. The mount assembly according to claim 9, wherein each clamp member has a convex shape and the corresponding sides of the base member have a concave recess, and wherein each clamp member and the base member together define a respective opening configured to receive the horizontally-extending or vertically-extending member therebetween.

15. A bracket assembly, the bracket assembly comprising:
a base member;
a first clamp member, a first end of the first clamp member pivotably coupled to a first side of the base member at a first location and a second opposing end of the first clamp member configured to be secured to the base member to secure a first pipe member between the first clamp member and the base member; and
a second clamp member, a first end of the second clamp member pivotably coupled to a second opposing second side of the base member at a second location, and a second opposing end of the second clamp member configured to be secured to the base member to secure a second pipe member between the second clamp member and the base member,
wherein the first and second locations are configured to be adjustable to accommodate first and second pipe members having different diameters.

16. The bracket assembly according to claim 15, wherein the first pipe member extends generally parallel to a ground plane and the second pipe member extends generally perpendicular to the ground plane, and wherein the bracket assembly secures the first pipe member to the second pipe member at a cross-over point between the first and second pipe members.

17. The bracket assembly according to claim 15, wherein a shaft member resides at an end of each clamp member, each shaft member defining a respective pivot location with the base member, and wherein the end of each clamp member comprises a pair of spaced apart arms extending outwardly therefrom, the shaft member extending between the arms.

18. The bracket assembly according to claim 15, wherein an opposing end of each clamp member comprises a recess, each recess configured to receive a respective fastener to secure the corresponding clamp member in a closed position relative to the base member, and wherein the base member comprises a pair of housing cavities each having an aperture, each cavity and corresponding aperture configured to receive a respective fastener configured to engage with a respective clamp member to secure the clamp members in closed position relative to the base member.

19. The bracket assembly according to claim 17, wherein the base member comprises one or more slots, the one or more slots configured to receive the respective shaft members of the first and second clamp members to form the respective pivot locations with the base member.

20. The bracket assembly according to claim 15, wherein, when a pipe member is secured between the base member and the first and/or second clamp member, a gap exists between the second opposing end of the first and/or second clamp member and the base member, and wherein a distance of the gap is approximately equal for when the pipe member has a first diameter or a second larger diameter.
